(19) United States
(12) Patent Application Publication
(10) Pub. No.: US 2015/0019277 A1
(43) Pub. Date: Jan. 15, 2015

(54) METHOD AND SYSTEM FOR AUTOMATING LUMPING SERVICES MANAGEMENT

(71) Applicant: DRW Legal Lumping Enterprises, Inc., Denver, CO (US)

(72) Inventors: Bruce E. Kostival, Lakewood, CO (US); Joseph M. Curry, Manhattan Beach, CA (US); Michael Petersen, Commerce City, CA (US); Michael D. Croker, Surprise, AZ (US); Steven E. Williams, Aurora, CO (US); Douglas R. White, Denver, CO (US); Sylvia M. Mares, Manhattan Beach, CA (US); Colleen M. Dugan, Matthews, NC (US); Mark A. Junewick, Littleton, CO (US); John Piaggio, Denver, CO (US)

(21) Appl. No.: 14/505,395

(22) Filed: Oct. 2, 2014

Related U.S. Application Data
(63) Continuation-in-part of application No. 14/043,769, filed on Oct. 1, 2013.
(60) Provisional application No. 61/709,079, filed on Oct. 2, 2012.
(60) Provisional application No. 61/885,986, filed on Oct. 2, 2013.

(51) Int. Cl. G06Q 10/06; G06Q 30/06

(52) U.S. Cl. CPC G06Q 10/0631; G06Q 30/0635; G06Q 10/06311
USPC 705/7.12

(57) ABSTRACT

One or more embodiments provide for automated management of lumping services. A method includes managing collection of on-site facility lumping services data. Payment collection is managed for the lumping services. Customer integrated file uploads containing data elements for field operations related to the lumping services is provided. Automated check-in and check-out of drivers at facilities for tracking lumping services is provided. Purchase orders for the lumping services are scheduled. Fee assessment for the purchase orders is performed. A determination is made for an initiated refund request for one or more of the purchase orders. Granted refund requests are dynamically processed for the one or more purchase orders. One or more status displays for the lumping services is provided.

### CROSS-REFERENCE TO RELATED APPLICATIONS

This application is a Continuation-in-Part of U.S. patent application Ser. No. 14/043,769, filed Oct. 1, 2013, which claims the priority benefit of U.S. Provisional Patent Application Ser. No. 61/709,079, filed Oct. 2, 2012, and additionally, this application claims the priority benefit of U.S. Provisional Patent Application Ser. No. 61/885,986, filed Oct. 2, 2013, all incorporated herein by reference in their entirety.

### TECHNICAL FIELD

One or more embodiments relate generally lumping services management, and in particular, to automation of lumping services management and accounting.

### BACKGROUND

Lumping services relate to professional freight handling, typically by 3^{rd} party operations contractors. A lumper unloads and loads freight (e.g., from trucks) for carriers at warehouses and distribution centers. The task of lumpers includes sorting and segregating the freight according to requirements at the warehouses. Due to lumping services workers repeatedly loading and unloading of freight, the productivity level of lumper workers are higher than non-lumper workers.

### SUMMARY

One or more embodiments relate to automated management of lumping services. One embodiment comprises a method includes managing collection of on-site facility lumping services data. In one embodiment, payment collection is managed for the lumping services. In one embodiment, customer integrated file uploads containing data elements for field operations related to the lumping services is provided. In one embodiment, automated check-in and check-out of drivers at facilities for tracking lumping services is provided. In one embodiment, purchase orders for the lumping services are scheduled. Fee assessment for the purchase orders is performed. In one embodiment, a determination is made for an initiated refund request for one or more of the purchase orders. In one embodiment, granted refund requests are dynamically processed for the one or more purchase orders. In one embodiment, one or more status displays for the lumping services is provided.

In one embodiment, a non-transitory computer-readable medium having instructions which when executed on a computer perform a method comprising managing collection of on-site facility lumping services data using an automated lumping services management system. In one embodiment, payment collection is managed for the lumping services. In one embodiment, customer integrated file uploads containing data elements for field operations related to the lumping services is provided. In one embodiment, automated check-in and check-out of drivers at facilities for tracking lumping services is provided. In one embodiment, purchase orders are scheduled for one of a fee waiver and a fee prepayment. In one embodiment, fee assessment for the purchase orders is performed. In one embodiment, it is dynamically determined if an initiated refund request should be granted for one or more of the purchase orders. In one embodiment, granted refund requests are processed for the one or more purchase orders. In one embodiment, one or more status displays for the lumping services is provided.

In one embodiment, a system for automated management of lumping services comprises a processor. In one embodiment, an operations and payment module uses the processor for managing on-site facility lumping services, processes lumping services information using one or more databases, schedules purchase orders, performs fee assessment for the schedule purchase orders, and manages payment collection and refund processing for the lumping services. In one embodiment, a vendor compliance module receives customer file uploads over a network from one or more a vendor systems. In one embodiment, the customer file uploads comprise data elements for field operations related to the lumping services. In one embodiment, one or more user interfaces provides for automated check-in and check-out of drivers at facilities for tracking lumping services, and provides one or more status displays for the lumping services.

These and other features, aspects and advantages of the one or more embodiments will become understood with reference to the following description, appended claims and accompanying figures.

### BRIEF DESCRIPTION OF THE DRAWINGS

FIG. 1 shows an example high level block diagram of an automation system (or Turn Time 2 (TT2)), according to an embodiment of the invention.

FIG. 2 shows an example process implemented by the Operations and Payment Center Module, according to an embodiment of the invention.

FIG. 3 illustrates an example process implemented by the Temporary Work Module, according to an embodiment of the invention.

FIG. 4 shows an example architecture of the automation system implementing an automation process, according to an embodiment of the invention.

FIG. 5 shows an example architecture of a system administrative module, according to an embodiment of the invention.

FIG. 6 shows an example web screen for user interaction with the automation system, according to an embodiment of the invention.

FIGS. 7A-7B show operations real-time daily dashboard with automation, according to an embodiment of the invention.

FIG. 8 shows an example display for trucks list option of the web display, according to an embodiment of the invention.

FIGS. 9A-9F show an example structure of system administration for automation, according to an embodiment of the invention.

FIG. 10 shows a block diagram of an example system 300 in which an embodiment of the invention may be implemented.

FIG. 11 shows an example administration log-in interface for access to a summary dashboard, according to an embodiment of the invention.

FIG. 12 shows an example administration entry interface for summary selection, according to an embodiment of the invention.

FIG. 13 shows an example location selection and type of summary dashboard selection interface, according to an embodiment of the invention.

FIG. 14 shows an example location selection interface for the summary dashboard, according to an embodiment of the invention.

FIG. 15A shows an example view of an active door time (ADT) summary dashboard, according to an embodiment of the invention.

FIG. 15B shows an example view of a detention summary dashboard, according to an embodiment of the invention.

FIG. 15C shows an example view of a combined ADT and detention summary dashboard, according to an embodiment of the invention.

FIG. 16 shows an example view of a scheduled purchase order (PO) interface, according to an embodiment of the invention.

FIG. 17 shows an example view of a scheduled PO fee decision interface, according to an embodiment of the invention.

FIG. 18 shows an example view of a scheduled PO waive fee interface, according to an embodiment of the invention.

FIG. 19 shows an example view of a scheduled PO prepay fee interface, according to an embodiment of the invention.

FIG. 20 shows an example view of assessed fees, according to an embodiment of the invention.

FIG. 21 shows an example view of assessed fee waive interface, according to an embodiment of the invention.

FIG. 22 shows an example view of an initiate refund interface, according to an embodiment of the invention.

FIG. 23A shows an example view of fee refunds that are awaiting processing interface, according to an embodiment of the invention.

FIG. 23B shows an example view of fee refunds that are awaiting completion, according to an embodiment of the invention.

FIG. 23C shows an example view of fee refund status, according to an embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Embodiments of the invention provide an automation process, system and business method for a web-based system for automating lumping services management. One or more embodiments of the invention essentially eliminate a paper intensive and manual data process environment to an automated and essentially paperless environment in lumping services for loading and unloading shipping containers and trailers.

One or more embodiments of the invention provide an efficient business operation and business application focused on providing customer real-time information and solutions for lumping services. An aspect of the invention is to identify opportunities with vendors to manage and improve timeliness of deliveries and create a cost efficient traffic flow model resulting in the reduction of labor costs.

One or more embodiments of the invention provide: (1) On-site data collection in lumping services, (2) reduction of labor costs for both field operation and quality management personnel, (3) functionality supporting a Payment Center Department to manage payment collection of all unloading services, (4) increase in data accuracy by providing customer integrated file uploads containing data elements for field operations and minimizing data input, utilizing customer data for ease of reconciliation, (5) improved account billing accuracy, (6) quicker check-in and check-out of drivers at facilities, and (7) use of hand-held mobile electronic devices for on-site management teams. Embodiments of the invention further provide a platform allowing for scalable and streamline speed-to-market enhanced functionality with a flexible infrastructure generating functionality such as Vendor Compliance.

One embodiment provides a method that includes managing collection of on-site facility lumping services data. In one embodiment, payment collection is managed for the lumping services. In one embodiment, customer integrated file uploads containing data elements for field operations related to the lumping services is provided. In one embodiment, automated check-in and check-out of drivers at facilities for tracking lumping services is provided. In one embodiment, one or more status displays for the lumping services is provided.

One embodiment provides a system for automated management of lumping services comprises a processor. In one embodiment, an operations and payment module uses the processor for managing on-site facility lumping services, processes lumping services information using one or more databases and manages payment collection for the lumping services. In one embodiment, a vendor compliance module receives customer file uploads over a network from one or more vendor systems. In one embodiment, the customer file uploads comprise data elements for field operations related to the lumping services. In one embodiment, one or more user interfaces provides for automated check-in and check-out of drivers at facilities for tracking lumping services, and provides one or more status displays for the lumping services.

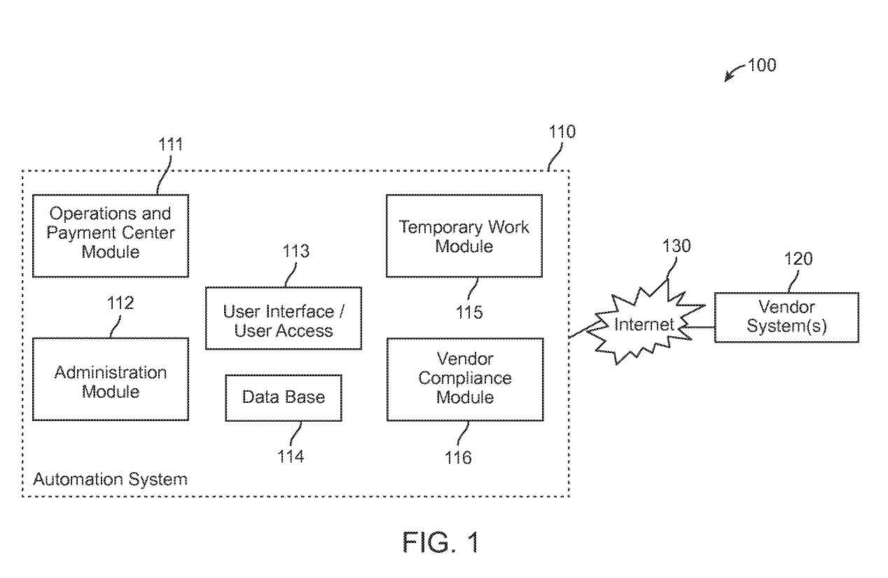

FIG. 1 shows an example high level block diagram a network 100 including an automation system (or TT2) 110, according to an embodiment of the invention. In one embodiment, the automation system 110 comprises: an Operations and Payment Center Module 111, a Temporary Work Module 115, an Administration Module 112 and a Vendor Compliance Module 116. In one embodiment, the automation system 110 may be implemented on a computer system and provides a user interface 113, such as web-based user interface using a network (e.g., Internet 130) accessed by a Vendor system(s) 120, through a web browser for user access and interaction with the automation system 110.

In one embodiment, the data for automation system 110 may be stored in one or more databases 114 for structuring the input/output data to/from the automation system 110. The functionality of the modules may be implemented in different ways and is not limited to the examples described herein.

According to an embodiment of the invention, a central entity may utilize the automation system 110 of the invention in conjunction with receiving schedules (e.g., from one or more customers) to determine and calculate Vendor Compliance categories and fees using the vendor compliance module 116. In one embodiment, the fee is determined at the time of check-in and the driver is informed of the fee and the process for collecting the fee at the time of payment. In one embodiment, the collection of the fee is managed at the same time the unloading charge is collected via a Payment Center using the operations and payment center module 111. In one embodiment, a full accounting of the program is tracked daily and provides a monthly detailed report of finances and trucks.

In one embodiment, the administration module 112 provides for various administration duties to be managed, such as updating of information and records, updating of displays, client information, payment requirements, processing of the different modules in the automation system 110, backups, etc.

In one embodiment, the Administration module 112 allows back-end support functions which include: audit messages and explanations, adding new warehouses, manage account structures for bill accounts, carriers and vendors, human resources for payroll structures and primary location assignments, batch management, invoicing, verification of purchase orders, etc.

In one embodiment, the Vendor Compliance Module 116 allows identification of timeliness of trucks per their scheduled appointment time and identification of unscheduled and rescheduled trucks, all of which impact the efficiency of Distribution Center operations and labor costs. In one embodiment, the overall intent of “Vendor Compliance” is to identify opportunities with vendors to manage and improve timeliness of deliveries and create a cost efficient traffic flow model resulting in the reduction of labor costs.

In one embodiment, the Vendor Compliance Module 116 provides a process to identify Rescheduled, Unscheduled, and Late Trucks and assess fees at the time of check-in at a Distribution Center. The daily uploaded schedules received from a vendor, such as a supermarket, are the Scheduled Appointments source, which are leveraged to calculate and determine the category type and fees. The Scheduled Appointment time compared to a predetermined Check-In time triggers an auto-calculation of the time difference, which is then used to determine the applicable fee. In one embodiment, both the “Scheduled Time” and “Check-In time” displays to the truck Driver on the signature pad and appears on the Driver Receipt.

In one embodiment, in the case of Rescheduled appointments, this information is provided via daily uploaded schedules and defaults the applicable fee. In one embodiment, if the situation includes multiple fees (e.g. a “Rescheduled” appointment and the truck is “Late”), both fees are calculated and collected.

In one embodiment, the Vendor Compliance Module 116 accommodates special circumstances with an immediate “over-ride” functionality of a calculated fee. In one embodiment, the over-ride functionality is performed real-time on-site with, for example, a click/touch/swipe of a button (on a screen, on a portable device, etc.), by said central entity or universal lumper (UL). In one embodiment, the over-ride is reserved for authorized personnel. In one embodiment, an over-ride requires a “waived fee” explanation. In one embodiment, this explanation appears on a “Fee Collection” summary report in the Waived Fee Explanation column of a display or interface.

In one embodiment, all Driver Unloads are checked in with a central entity if late for a scheduled appointment, and will also be assessed a late fee. In one embodiment, the system may automatically color code the Driver Unload (in a display or interface) so that monitors are aware a fee is pending collection since an unloading charge is not applicable. In one example embodiment, all fees associated to the Vendor Compliance module 116 are Cash transactions. In one embodiment, if there is an unload fee and the load is on account, the unload fee will continue to bill to the appropriate bill account. In one embodiment, the Vendor Compliance Fee is a “Cash” account. In one embodiment, said supermarket to which the truck deliveries are made, may determine the exclusion of any vendor from the program at the time of the program set-up. In one embodiment, the Driver receives an itemized accounting of the transaction on the Driver Receipt, which also includes the Scheduled Time and Check-In time.

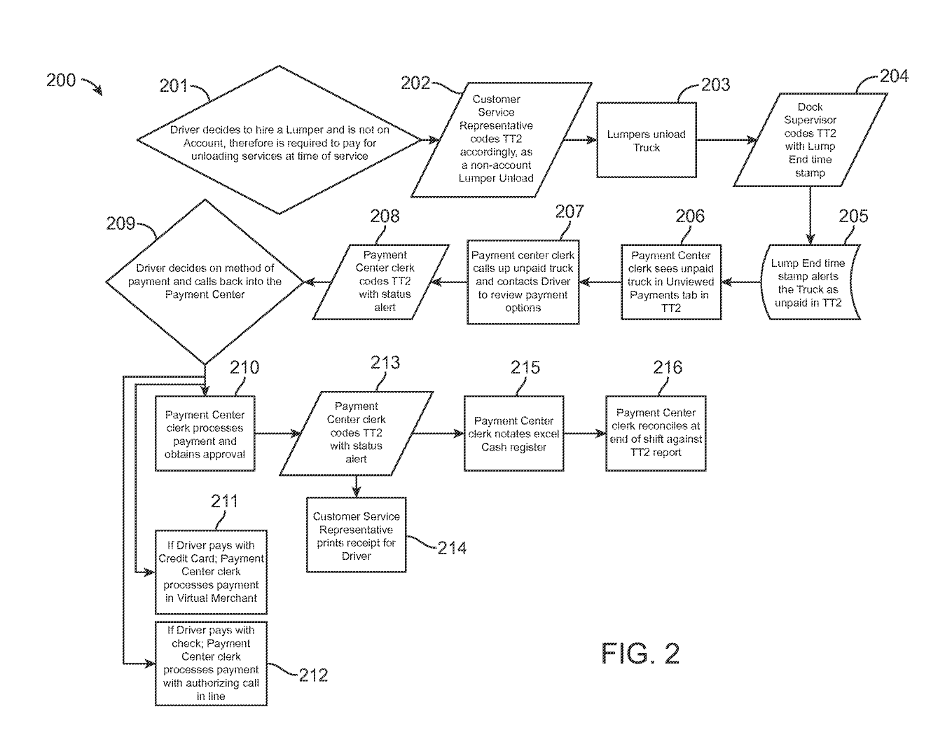

FIG. 2 shows an example process 200 implemented by the Operations and Payment Center Module 111 (FIG. 1), according to an embodiment of the invention. In one embodiment, the Operations and Payment Center Module 111 provides functionality for a Payment Center Department to enable processing of payments for carriers utilizing a consolidated call center for collecting payments, such as cash, credit cards, and checks. The Operations and Payment Center Module 111 further provides report consolidation, management, and presentation of data. The Operations and Payment Center Module 111 increases functional efficiency pertaining to all “truck” related functionality and provides functionality for Field Operations and Quality Data Management processes and procedures.

In one embodiment, the example payment center process 200 may start with block 201, where a driver determines to hire a lumper and is not presently on an account. Therefore, the driver is required to pay for the unloading services at the time of service. In one embodiment, in block 202 a customer service representative codes or enters information in the automation system 110 (or TT2) through an interface 113 and/or using the administration module 112 accordingly as a non-account Lumper Unload. In block 203 the lumpers unload the truck.

In one embodiment, in block 204 a dock supervisor codes or enters the Lump End Time (or time stamp) information in the automation system 110 (e.g., through a hand held mobile electronic device). In one embodiment, in block 205 the Lump End time stamp alerts the truck as being unpaid in the automation system 110. In one embodiment, in block 206 the payment center clerk may see a display indicating an unpaid truck in an unpaid Payments tab on a display interface. In one embodiment, in block 207 the payment center clerk opens information page for the unpaid truck (e.g., calls up the unpaid truck) and communicates with the driver (e.g., using the driver contact information from the automation system 110) to review available payment options.

In one embodiment, in block 208 the payment center clerk codes or enters information into the automation system 110 with a status alert. In one embodiment, in block 209 the driver determines on a method of payment and calls back to the payment center with this information. In one embodiment, in block 210, the payment center clerk processes the payment and obtains approval. In block 211, if the driver pays via credit card, the payment center clerk processes the payment (e.g., via a virtual merchant account, via a handheld mobile device, etc.). In one embodiment, in block 212 if the driver pays via check, the payment center clerk processes the payment via authorizing the payment online, via a call to a bank, or authorizing authority, etc.

In one embodiment, in block 213 the payment center clerk codes or enters information into the automation system 110 with a status alert update. In one embodiment, in block 214 a customer service representative prints a receipt for the driver, or an automated email, text message or fax is generated (which may depend on receipt preference). In one embodiment, in block 215 the payment center clerk notates a payment element, such as an excel cash register, etc. In one embodiment, in block 216 the payment center clerk reconciles at the end of a shift against the automated system 110 accounting report.

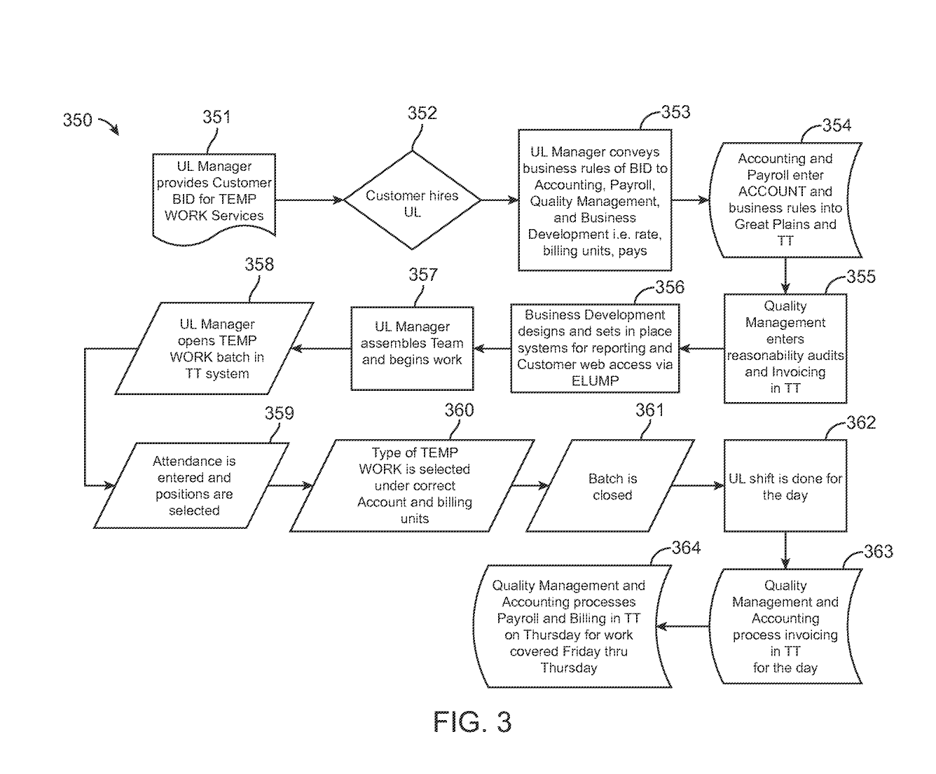

FIG. 3 illustrates an example process 350 implemented by the Temporary Work Module 115, according to an embodiment of the invention. In one embodiment, the Temporary Work Module 115 allows for all non-truck related work to be processed for payroll and invoicing. In one embodiment, the Temporary Work Module 115 includes work such as: Sanitation and temporary work provided to a customer. In one embodiment, the temp work process 350 starts with block 351, where a UL manager provides a customer bid for temporary (Temp) work services. In one embodiment, in block 352 the customer decides whether to hire the UL or not. In one embodiment, if the customer hires the UL, the process 350 continues to block 353 where the UL manager conveys business rules of the bid to accounting, payroll, quality management and business development (e.g., rate, billing units, ways to pay, etc.).

In one embodiment, in block 354 accounting and payroll enter the account and business rules into the automated system 110 (and optional into a specified database for a particular location or area). In one embodiment, in block 355, quality management enters reasonability audits and invoicing into the automated system 110. In one embodiment, in block 356 business development designs and sets in place systems for reporting and for customer access (e.g., via Internet web page, an electronic lump network, etc.). In one embodiment, in block 357 the UL manager assembles a team and begins work using the automated system 110.

In one embodiment, in block 358 the UL manager opens a Temp work batch in the automated system 110. In one embodiment, in block 359 attendance is entered (e.g., for workers) and positions are selected. In one embodiment, in block 360 the type of Temp work is selected under the correct account and billing units entered into the automated system 110. In one embodiment, in block 361 the batch is then closed. In one example embodiment, in block 362 after the batch is closed, the UL shift is completed for the day. In one embodiment, in block 363 quality management and accounting process invoicing in the automated system 110 for the day. In one example, in block 364 quality management and accounting processes payroll and billing in the automated system 110 on a Thursday for work covered for Friday through Thursday.

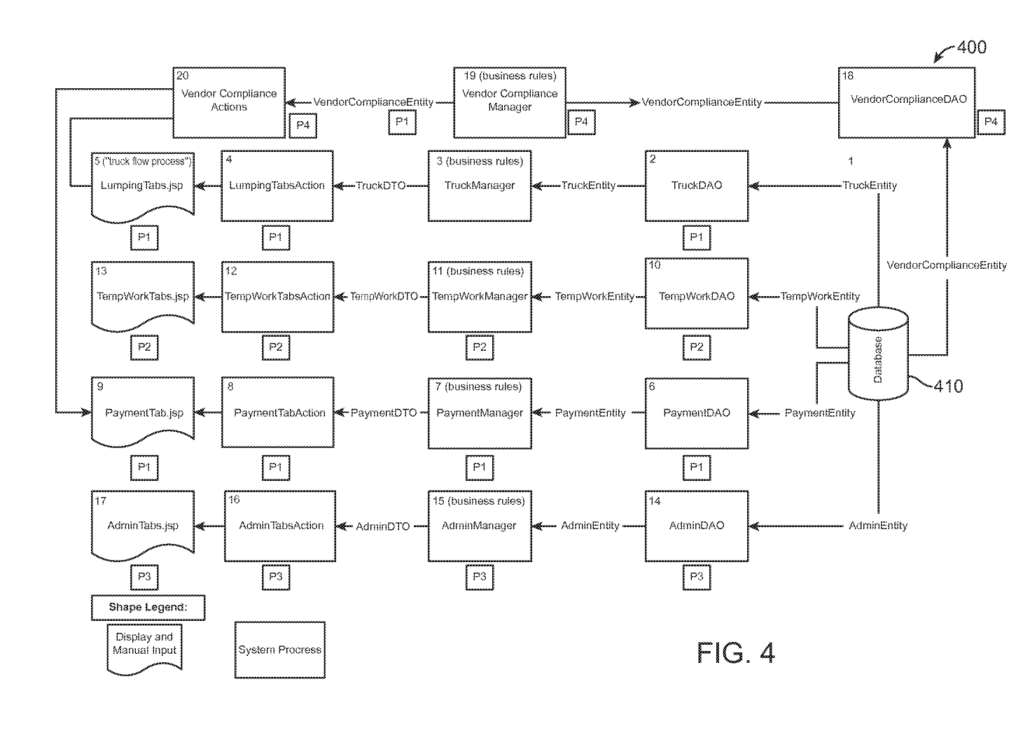

FIG. 4 shows an example architecture 400 of the automation system 110 (FIG. 1) implementing an automation process, according to an embodiment of the invention. In one embodiment, the process blocks comprise 1 through 20. In one example embodiment, the designation P1 indicates that the associated process blocks are components of the Operations & Payment Center Module 111. In one embodiment, the designation P2 indicates that process blocks 10 through 13 are components of the Temporary Work Module 115. In one embodiment, the designation P3 indicates that process blocks 14 through 17 are components of the Administration module 112. In one embodiment, the designation P4 indicates that process blocks 18-20 are components of the Vendor Compliance module 116. In one embodiment, data/information is stored/obtained/created/deleted in the database 410.

In one embodiment, the Truck Manager process blocks 1-5 in the architecture 400 comprise a TT2 Truck Manager process as follows. In one example embodiment, UL location selections are validated based on Active Directory (AD) security for a verified TT2 user. In one embodiment, open receiving batches are displayed (e.g., via an interface, monitor, etc.) by UL location along with truck counts by a lump process step in a location grid for validated locations. In one example embodiment, UL location selection is allowed from the location grid or the location link containing validated location information.

In one example embodiment, the automated system 110 verifies that a TT2 batch is open for the selected UL location prior to allowing navigation to the UL location truck list in the display. In one embodiment, the truck list provides a detail view of trucks at the selected UL location. In one example embodiment, a user may navigate to a batch management tab and display “Open Batch” control if the Truck list selected and the batch are not open for UL location. In one embodiment, the interface 113 allows selection of a batch contact and telephone number from a list of active employees. In one example embodiment, the list of employees may comprise employees assigned to a UL location, and employees assigned to a lumping facility. In one embodiment, a procedure to load trucks is executed, if any, from the UL location appointment queue on the batch opening. In one embodiment, a UL control number is assigned for each truck loaded from the UL location appointment queue.

In one embodiment, in the truck list view, truck counts are displayed for each truck list tab. In one example, the truck list tabs represent the flow and details the steps in the UL lumping process.

In one embodiment, upon entry to the truck list, the truck list is defaulted to focus on the status tab. In one embodiment, the status tab displays all trucks in process, but not completed for the selected UL location. In one embodiment, information on the status tab of the interface 113 or display may include the carrier name, assigned UL control number, trailer, lump status (last complete step in the lump process), date/time of lump status (date/time that the step was completed), assigned dock for the truck and assigned door number for the truck.

In one example embodiment, after successful TT2 login, a TT2 landing page may display links down the page to access the following TT2 options:
Location Selection—allowing selection of validated central entity (e.g., UL) locations;
Batch Management—allowing opening and closing of TT2 location batches;
Attendance Management—allowing employee check-in and check-out;
Daily Operating Report Form (DORF)—allowing reporting on checked in employees; and
Location grid—allowing access to any validated UL locations with an open DATAENTRYREALTIME batch.

In one embodiment, the TT2 landing page may display links across the display page to access the following TT2 features:
Administration—for use by developers;
Truck List—providing navigation to TT2 location details;
Search Trucks—providing searches via text strings in specified TT2 fields for validated UL locations;
TT2 Alerts—providing the display attendance alerts for validated UL locations; and
Logout—allowing log out of credentialed TT2 users.

In one example embodiment, UL location selections are validated based on Active Directory (AD) security for credentialed TT2 users. In one example embodiment, open receiving batches are displayed by UL location along with truck counts by lump process step in a location grid for validated locations. In one embodiment, UL location selection is allowed from the location grid or location link containing validated location information.

In one embodiment, it is verified that a TT2 batch is open for the selected UL location prior to allowing navigation to the UL location truck list. In one example embodiment, the truck list provides a detail view of trucks at the selected UL location. In one embodiment, if a TT2 batch is not open:
the automated system 110 provides for:
   navigating to batch management tab and display “Open Batch” control on selection of Truck List for validated UL location;
   allowing selection of batch contact and phone number from list of active employees: employees assigned to UL location, and employees assigned to lumping facility; these selections are displayed in the upper right corner of the TT2 landing page for reference by all TT2 users.
executing a procedure to load trucks, if any, from the UL location appointment queue on batch opening; and
assigning a UL control number for each truck loaded from the UL location appointment queue.

In one embodiment, in the truck list view, the automated system 110 displays truck counts for each truck list tab. In one example embodiment, the truck list tabs represent the truck flow through the lumping process. In one embodiment, the truck list tabs also provide access to each truck in the UL lumping process.

In one embodiment, upon entry to the truck list, the truck list is defaulted for focusing to the status tab. In one example, the status tab may always be displayed in this view. In one example embodiment, as with every tab in this view, the carrier link allows entry to truck details at the selected process step. In one example, tabs available for display in this view based on the AD security set up for the credentialed TT2 user include:
Schedule—displays trucks that have not moved past the Check In step:
   Carrier—carrier delivering the load;
   Trailer—carrier trailer designation;
   Tractor—carrier tractor designation; and
   Scheduled time—scheduled appointment time;
Check In—displays trucks that have not moved past the In Door step:
   Carrier—carrier delivering the load;
   Trailer—carrier trailer designation;
   Tractor—carrier tractor designation;
   Scheduled time—scheduled appointment time; and
   Check in time—time the driver checked in with the lumper service;
In Door—displays trucks that have not moved past the PO/Billing step:
   Carrier—carrier delivering the load;
   Trailer—carrier trailer designation;
   Tractor—carrier tractor designation;
   Door assign time;
   Dock—dock assignment for the unload; and
   Door—door assignment for the unload
PO/Billing—displays trucks that have not moved past lump start:
   Carrier—carrier delivering the load;
   Trailer—carrier trailer designation;
   Tractor—carrier tractor designation;
   Lump end time—unload end time;
   Driver unload (DUL)—yes or no to designate driver unload;
   Dock—dock assignment for the unload; and
   Door—door assignment for the unload;
Load Stats—displays trucks active in the lumping phase of the process:
   Carrier—carrier delivering the load;
   Trailer—carrier trailer designation;
   Tractor—carrier tractor designation;
   Lump end time—unload end time;
   Driver unload (DUL)—yes or no to designate DUL;
   Dock—dock assignment for the unload; and
   Door—door assignment for the unload
Lump Start—displays trucks that have not moved past lump end:
   Carrier—carrier delivering the load;
   Trailer—carrier trailer designation;
   Tractor—carrier tractor designation;
   Door assign time—time of the dock/door assignment;
   Lump start time—unload start time;
   Dock—dock assignment for the unload; and
   Door—door assignment for the unload;
Lump End—displays trucks that do not have completed bills:
   Carrier—carrier delivering the load;
   Trailer—carrier trailer designation;
   Tractor—carrier tractor designation;
   Lump start time—unload start time;
   Lump end time—unload end time;
   Dock—dock assignment for the unload; and
   Door—door assignment for the unload;
Check Out—displays trucks that have not been paid:
   Carrier—carrier delivering the load;
   Trailer—carrier trailer designation;
   Tractor—carrier tractor designation;
   Lump end time—unload start time;
   Check out time—time the driver checked out of the facility;
   Dock—dock assignment for the unload;
   Door—door assignment for the unload;
   Driver phone number—carrier driver cell phone number; and
         $$ Due—unload bill amount payable before carrier leaves the facility;
Payment—displays trucks that have not been receipted:
   Carrier—carrier delivering the load;
   Control number—warehouse load identifier;
   Trailer—carrier trailer designation;
   Tractor—carrier tractor designation;
   Lump end time—unload start time;
   Alert—any alert associated with the unload or unload payment;
         $$ Due—unload bill amount payable before carrier leaves the facility; and
   Payment center contact—assigned payment center clerk;
Alerts—displays all trucks with payment alerts:
   Carrier—carrier delivering the load;
   Alert—any alert associated with the unload or unload payment;
   Alert time—time the alert was generated;
   Driver phone number—carrier driver cell phone number;
   Door—door assignment for the unload; and
   Payment center contact—assigned payment center clerk;
Closed—displays all trucks that are checked out of the facility:
   Carrier—carrier delivering the load;
   Control number—warehouse load identifier;
   Trailer—carrier trailer designation;
   Driver phone number—carrier driver cell phone number;
   Status—current status of the unload (processing step);
   Status date/time—current unload status time stamp;
   Dock—dock assignment for the unload; and
   Door—door assignment for the unload;
Status—displays all trucks that are checked in at this facility:
   Carrier—carrier delivering the load
   Control number—warehouse load identifier
   Trailer—carrier trailer designation Lump status—last completed step in the unload process
   Lump status date/time—time stamp of the last completed step
   Dock—dock assignment for the unload; and
   Door—door assignment for the unload.

In one example embodiment, from the truck list view, the following truck detail tabs may be available:
Setup—used for adding a truck and/or changing truck attributes:
   Move this truck to a different open batch (pick list);
   Unload type—lumped load or driver unload (DUL);
   Dropped—was the trailer dropped at the dock (no tractor);
   Backhaul—is the load a backhaul (from another customer location); and
   Truck type—bobtail, On Dock, Trailer only, Trailer/Tractor;
Schedule—includes truck schedule information:
   Rescheduled (vendor compliance);
   Scheduled Time—scheduled appointment time;
   Scheduled Carrier—scheduled carrier;
   Actual Carrier—carrier delivering the load;
   Assigned Dock—unloading dock assignment; and
   Purchase Orders (POs) on Truck—confirmed POs on the truck;
Check-In—includes truck check-in information:
   Check-in time—time the driver checked in with the lumper service;
   Tractor identifier—carrier tractor designation;
   Trailer identifier—carrier trailer designation;
   Load lock count—number of load locks in the trailer;
   Other drops?—indication that the carrier has other stops;
   Seal number—number associated with the door seal, if any;
   Dispatch phone—carrier dispatch phone number; and
   Driver phone—truck driver's phone number;
In Door—includes truck door assignment information:
   Door assignment time—time of the dock/door assignment;
   Dock (display only)—dock assignment for the unload;
   Door number—door assignment for the unload; and
   Bills-in time—time the bills were taken to customer receiving;
PO/Billing—includes PO and information for signature:
   Bills In Time—time the bills were taken to customer receiving;
   POs on truck—confirmed POs on the truck; Special circumstance (e.g., exclusively used in a particular location, such as Tracy CA—TENDERED);
   Lumping bill account—bill account for lumper charges;
   Vendor compliance info if applicable—applicable fee charges; allow fee overrides; and
   Driver signature—driver signature confirming check-in time;
Load Stats—includes lump information:
   Start pallets—loaded pallets on the truck;
   End pallets scheduled—the number of ending pallets scheduled for the unload;
   End pallets—actual end pallets resulting from the unload;
   Load size—full or partial;
   Load type—full, palletized, slip;
   Labor type—breakdown, build-up, floor, load-up, pull off, re-throw; and
   Additional notes—any notes pertaining to the unload;
Lump Start—includes information related to starting the lump:
   Subject to count—yes or no; if yes, breakdown will occur after the driver leaves the warehouse;
   Lump start time—unload start time;
   Lump down start and end (allow 3)—start and end time of any lump down time;
   Lumpers grid (e.g., lumpers on truck)—lumper(s) assigned to the unload and their percentage;
   Special circumstance (unrestricted)—any unload special circumstances affecting the billing; in some cases the pallet count may be recorded as well;
Lump End—includes information related to finishing the lump:
   Lump end time—unload end time;
   Overage, shortage and damage (OS&D)—indication that the load has an overage, a shortage or damage compared to the driver bills identifying the load;
   POs on truck—PO, vendor/commodity, items, cases; and
   Lumpers on truck—lumper(s) assigned to the unload and their percentage;
Check-Out—includes check out information:
   Lump start time (display only)—unload start time;
   Lump end time (display only)—unload end time;
   Start pallets (display only)—loaded pallets on the truck;
   Scheduled pallets (display only)—the number of ending pallets scheduled for the unload;
   End pallets (display only)—actual end pallets resulting from the unload;
   Special circumstance (display only)—any unload special circumstances affecting the billing; in some cases the pallet count will be recorded as well;
   Bills out time—time the bills came out of customer receiving; and
   Bill to driver time—time the bills were handed to the driver;
Payment—includes payment and alerts:
   System wide alert (pick list)—to inform Ops of any system wide issues (e.g. payment check processing down);
   Payment center contact—assigned payment center clerk;
   Driver phone number—carrier driver cell phone number;
   Lumping bill account—bill account for lumping charges;
   Calculated lumping bill—amount due for unloading services; this amount considers any special circumstances recorded for the unload;
   Allow entry of cash, check and credit payments with associated details—form of payment for unloading services;
   Total lumping collected (display only)-calculated amount paid for lumping services;
   Payment alert (pick list)—alerts associated with the payment for lumping services (e.g. waiting for dispatch); and
   Payment collected on site—checkbox to record that cash was collected for lumping services at the warehouse;
Receipt—include all information pertinent to driver receipt:
   Lumping bill account (display only)—bill account for lumping charges;
   Calculated lumping bill amount (display only)—amount due for unloading services;
   this amount considers any special circumstances recorded for the unload;
   Amount to be invoiced (display only)—charges for lumping services to be invoiced to the warehouse or carrier; and
   Additional notes—any additional information operations has to provide for the unloading service.

In one embodiment, the truck list view may have two additional controls:
Add—allows a truck to be added to the selected location;
   Unload type—driver unload or lumped load;
   Dropped—is the trailer dropped?;
   Backhaul—is the load a warehouse backhaul?; and
   Truck type—bobtail, on-dock, trailer only, tractor/trailer; and
Done—controls to allow user navigation back to the location grid.

In one embodiment, the pages in the truck detail view may include the following:
Header—includes pertinent information regarding the selected truck:
   Actual carrier name;
   Assigned door;
   Carrier trailer number;
   Scheduled appointment time for the unload; and
   UL assigned Turn Time control number;
Standard page controls—controls available on each detail page:
   Save—save any changes on the current page;
   Cancel—cancel any changes on the current page;
   Gate Pass—display gate pass with print option; the gate pass will include any and all recorded information for the current truck; and
   Clear Page—available on all tabs except Setup; clears data on the current page (except PO and lumper grids).
Page specific controls:
   Clear Fee Payments—available on the payment tab to clear any fee payments recorded for the truck; and
   Pending—available on the receipt tab to allow unused trucks in the open batch to be moved to the Pending queue.

In one embodiment, TT2 Damage Control functionality may include the following:
Damage Control Features:
   Integration of damage control data capture with TT2 application;
   Track damage by PO on each load;
   Upload damage photographs in the TT2 application;
   Individual damage reports are posted to the customer web site; and
   Summary damage reports are posted to the customer web site; and
Damage Control Fields:
   Damage caused by—Vendor or Lumper;
   Warehouse supervisor name—Customer;
   Employee/Lumper name (Lumping service);
   Notes (pick list of possible causes);
   Where is the damaged product? (pick list);
   Damage type (pick list);
   UPC number or Product code; cases; and
   Damage photos (e.g., limited to 3, 4, etc.).

In one embodiment, Vendor Compliance functionality of the automated system 110 may comprise the following:
Vendor Compliance Features:
   Vendor compliance fees are setup at the dock level;
   Vendor compliance fee system overrides setup at dock level:
      Override by Bill Account;
      Override by Carrier; and
      Override by Vendor;
   Integrate vendor compliance processing with TT2 application;
   Multiple vendor compliance fees may be charged per load;
   Allow vendor compliance fee override (reason pick list);
   Record vendor compliance fees separate from lumping charges;
   Do not allow fee override for the following reasons:
      Payments are recorded for the fee; and
      The fee setup prohibits overrides;
   Allow fee payments to be cleared on Payment tab;
   Allow load payment attributes to be copied to fee
   payments;
   Vendor Compliance fees may include the following:
      UNSCHEDULED—truck arrives without a scheduled appointment;
      Late 31-60 minutes—truck arrives 31-60 minutes late for scheduled appointment;
      Late 61+ minutes—truck arrives over 60 minutes late for scheduled appointment;
      NO SHOW—truck does not arrive for a scheduled appointment (designated as a reschedule on customer appointment list);
Vendor Compliance Fields:
   Reschedule—view only indication of a load reschedule;
   Calculate fees on save of Check-In tab;
   Display fees and allow overrides on PO/Billing tab along with:
      Schedule time (view only);
      Check-in time (view only);
      Driver phone number (view only); and
      Driver signature (display schedule and
      check-in time on signature pad);
   Display fees and allow payment setup on Payment tab; and
   Display fee payments and/or override information on receipt.

In one embodiment, setup tab functionality comprises the following:
Providing tailoring data capture screens based on truck type (lumper or DUL); and
Providing tailoring data capture screens based on truck configuration:
   Dropped trailer;
   Backhaul;
   Bobtail;
   ON DOCK; and
   Tractor/trailer.

In one embodiment, the payment list view tab comprises the following functionality:
Access may be limited to the call center staff and Ops directors;
Contact assignment:
   Missing $ Due indicates an error in truck processing;
      Clerk navigates to payment detail tab;
      Clerk clicks Save to set the ‘No Calculated Bill Amount’ alert;
   NULL payment clerk and $ Due fields;
      Clerk navigates to payment detail tab;
      Clerk clicks Save to set the ‘Payment Center Contact Assigned’ alert; and
      Clerk calls driver to inform them of lumping charges and to process payment;
Red alerts indicate that payment center needs operation's help; and
Any truck with unpaid lumping charges or fees shows in the list.

In one embodiment, the payment detail tab comprises the following functionality:
Initial Save sets the default alert:
   No Calculated Bill Amount (incomplete truck processing); and
   Payment Center Contact Assigned;
Initial Save sets payment center contact;
Driver telephone number will be displayed for the clerk to contact a driver;
Any system wide alerts are set here;
Lumping charges collected are recorded here; and
Fees collected are recorded here.

In one embodiment, the Vendor Compliance Manager process blocks 18-20 in the architecture 400 uses the Vendor Compliance Module 116 and is integrated and managed within the TT2 110 framework. In one embodiment, Vendor Compliance functionality comprises the following:
Vendor Compliance Features:
   Vendor compliance fees are setup at the dock level;
   Vendor compliance fee system overrides setup at dock level:
      Override by Bill Account;
      Override by Carrier; and
      Override by Vendor;
   Integrate vendor compliance processing with TT2 110 application;
   Multiple vendor compliance fees may be charged per load;
   Allow vendor compliance fee override (reason pick list);
   Record vendor compliance fees separate from lumping charges; and
   Do not allow fee override for particular reasons.

In one embodiment, the Vendor Compliance module 116 provides for fee payments that are recorded and managed by a TT2 payment manager. In one embodiment, the fee setup prohibits overrides:
Allowing fee payments to be cleared on Payment tab;
Allowing load payment attributes to be copied to fee payments;
Vendor Compliance fees may include the following:
   UNSCHEDULED—truck arrives without a scheduled appointment;
   Late 31-60 minutes—truck arrives 31-60 minutes late for scheduled appointment;
   Late 61+ minutes—truck arrives over 60 minutes late for scheduled appointment; and
   NO SHOW—truck does not arrive for a scheduled appointment (designated as a reschedule on customer appointment list).

In one embodiment, the vendor compliance fields may comprises the following:
Reschedule—view only indication of a load reschedule;
Calculate fees on save of Check-In tab;
Display fees and allow overrides on PO/Billing tab along with:
   Schedule time (view only);
   Check-in time (view only);
   Driver phone number (view only); and
   Driver signature (display schedule and check-in time on signature pad);
Display fees and allow payment setup on Payment tab; and
Display fee payments and/or override information on receipt.

In one embodiment, the Temp Work Manager process blocks 10-13 in architecture 400 uses the Temp Work Module 110 and may include the following functionality. After successful TT2 login, the TT2 landing page may include links down the page to access the following TT2 options:
Location Selection—allow selection of validated UL locations;
Batch Management—allow open and close of TT2 location batches;
Attendance Management—allow employee check in and check out;
Daily Operating Report Form (DORF)—allow reporting on checked in employees; and
Location grid—allowing access to any validated UL locations with an open DATAENTRYREALTIME batch.

In one embodiment, the TT2 landing page display may include links across the page to access the following TT2 features:
Administration—for use by developers;
Temp Work List—providing navigation to TT2 location details;
Search Temp Work—search using text strings in specified TT2 fields for validated UL locations; and
Logout—allowing log out of credentialed TT2 user session.

In one embodiment, UL validation of location selections may be based on AD security for credentialed TT2 users. In one embodiment, an interface or display shows open temp work batches by UL location along with temp work counts by temp work process step in location grid for validated locations. In one embodiment, UL location selection is allowed from the location grid or location link containing validated location information.

In one embodiment, verification is provided such that a TT2 batch is open for the selected UL location prior to allowing navigation to the UL location temp work list. In one example embodiment, the temp work list provides a detail view of currently open temp work at the selected UL location. In one example, if a TT2 batch is not open:
Navigate to batch management tab and display “Open Batch” control on selection of Temp Work List for validated UL location;
Allow selection of batch contact and phone number from list of active employees:
   employees assigned to UL location; and
   employees assigned to lumping facility;
   These selections may be displayed in the upper right corner of the TT2 landing page for reference by all TT2 users;
Execute procedure to load assigned temp work, if any, from the UL location appointment queue on batch opening; and
Assign a UL control number for each temp work event loaded from the UL location appointment queue.

In one embodiment, in the temp work list view, the interface or display shows temp work counts for each detail temp work list tab. In one example embodiment, the temp work list tabs represent the temp work flow through the UL process. In one embodiment, the temp work list tabs also provide access to each temp work item in the UL process.

In one embodiment, upon entry to the temp work list, the display defaults the temp work list focus to the status tab. In one example embodiment, the status tab may be displayed for each and every credentialed TT2 user in this view. In one embodiment, as with every tab in this view, the work item link allows entry to temp work details at the selected process step. In one example embodiment, tabs available for display in this view may be based on the AD security set up for the credentialed TT2 user to include:
Schedule—displays temp work that has not moved past the Authorization step:
   Location—temp work location;
   Scheduled time—temp work start time (if any); and
   Authorization—customer contact authorizing the temp work;
Authorization—displays temp work that has not moved past the payment step:
   Location—temp work location;
   Scheduled time—temp work start time (if any); and
   Authorization—customer contact authorizing the temp work;
Payment—displays temp work that has not been receipted:
   Control number—temp work identifier;
   Location—temp work location;
   Scheduled time—temp work start time (if any);
   Authorization—customer contact authorizing the temp work;
   Alert—any alert associated with the temp work or temp work payment;
         $$ Due—temp work bill amount payable; and
   Payment center contact—assigned payment center clerk;
Alerts—display all temp work with payment alerts:
   Location—temp work location;
   Scheduled time—temp work start time (if any);
   Authorization—customer contact authorizing the temp work;
   Contact phone number—temp work authorizer cell phone number;
   Alert—any alert associated with the unload or unload payment;
   Alert time—time the alert was generated; and
   Payment center contact—assigned payment center clerk;
Closed—display all temp work that has completed at the facility:
   Control number—temp work identifier;
   Location—temp work location;
   Scheduled time—temp work start time (if any);
   Authorization—customer contact authorizing the temp work; and
   Contact phone number—temp work authorizer cell phone number;
Status—display all temp work scheduled at this facility:
   Control number—temp work identifier;
   Location—temp work location;
   Scheduled time—temp work start time (if any);
   Authorization—customer contact authorizing the temp work; and
   Contact phone number—temp work authorizer cell phone number.

In one embodiment, from the temp work list view, the following temp work detail tabs may be available:
Schedule—used for adding temp work and/or changing temp work attributes; include temp work schedule information:
   Move this temp work to a different open batch (pick list);
   Work Type—type of work specified by customer;
   Work Units—Hours, pallets, cases, truck; and
   Notes—additional information clarifying the temp work;
Authorization—include temp work setup information:
   Temp work start time—time the temp work was authorized;
   Temp work bill account—bill account for temp work charges;
   Temp work authorization—customer employee authorizing the temp work; and
   Authorization signature—signature of customer employee authorizing the temp work;
Payment—include payment and alerts:
   System wide alert (pick list)—to inform Ops of any system wide issues (e.g. payment check processing down);
   Payment center contact—assigned payment center clerk;
   Contact phone number—temp work authorizer cell phone number;
   Temp work bill account—bill account for temp work charges;
   Calculated temp work bill—amount due for temp work;
   Allow entry of cash, check and credit payments with associated details—form of payment for temp work;
   Total temp work collected (display only)—calculated amount paid for temp work;
   Payment alert (pick list)—alerts associated with the payment for temp work (e.g. waiting for dispatch); and
   Payment collected on site—checkbox to record that cash was collected for temp work at the customer location;
Receipt—includes all information pertinent to customer receipt:
   Temp work bill account (display only)—bill account for temp work;
   Calculated temp work bill amount (display only)—amount due for performance of temp work;
   Amount to be invoiced (display only)—charges for temp work to be invoiced to the customer; and
   Additional notes—any additional information operations has to provide for the temp work.

In one embodiment, the temp work list view may have two additional controls:
Add—allows temp work to be added to the selected location:
   Work type—type of temp work specified by the customer; and
   Work Units—temp work units for billing purposes; and
Done—control to allow user navigation back to the location grid.

In one embodiment, the pages in the temp work detail view may include the following:
Header—includes pertinent information regarding the selected truck:
   Location name;
   Work Type;
   Work Units;
   Scheduled temp work time (if any); and
   UL assigned control number; and
Standard page controls—controls available on each detail page:
   Save—save any changes on the current page;
   Cancel—cancel any changes on the current page; and
   Clear Page—available on all tabs except Setup; clears data on the current page.

In one embodiment, the Payment Manager process blocks 6-9 in architecture 400 may have the following functionality. In one embodiment, payments are integrated and managed within the TT2 automated system 110 framework. In one embodiment, the following views may be available on an interface or display:
Payment list view:
   View all payments pending:
      Lumping charge only payments;
      Fee only payments; and
      Lumping charges+fee payments; and
   Provides details for efficient payment processing;
Payment detail view:
   Drill into truck payment and allow payment processing; and
   Lumping charges and fees.

In one embodiment, the payment list view tab comprises the following functionality:
Access limited to call center staff and Ops directors;
Contact assignment:
   Missing $ Due indicates an error in truck processing;
      Clerk navigates to payment detail tab;
      Clerk clicks Save to set the ‘No Calculated Bill Amount’ alert; and
      No payment center clerk assignment is made;
   NULL payment clerk and $ Due fields:
      Clerk navigates to payment detail tab;
      Clerk clicks Save to set the ‘Payment Center Contact Assigned’ alert; and
      Clerk calls driver to inform them of lumping charges and to process payment;
Red alerts indicate that payment center needs operation's help; and
Any truck with lumping charges or fees pending displays in list.

In one embodiment, the payment detail tab comprises the following functionality:
Initial Save sets the default alert:
   No Calculated Bill Amount (incomplete truck processing); and
   Center Contact Assigned;
Initial Save sets payment center contact:
   Shows payment clerk assignment on list view; and
   Assignment relinquishes on truck validation error;
Driver phone number will be displayed for clerk to contact driver; and
Payment center clerks set system wide alerts on payment details page;
Lumping charges collected are recorded here:
   Payment method; and
   Payment amount;
Fees collected are recorded here:
   Payment method;
   Payment amount; and
   Copy feature allows lumping method to be copied to fee payment.

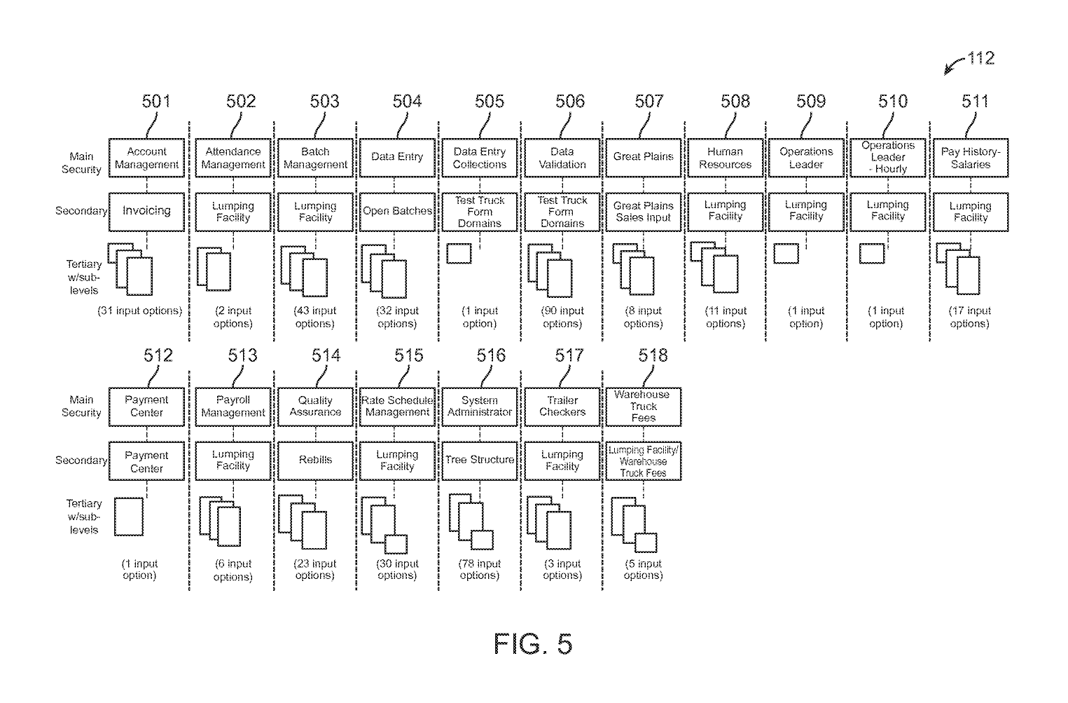

FIG. 5 shows an example architecture of the functional blocks for the (system) administrative module 112, according to an embodiment of the invention. In one example embodiment, the following functional main security blocks are provided: account management 501, attendance management 502, batch management 503, data entry 504, data entry collections 505, data validation 506, great plains 507, human resources 508, operations leader 509, operations leader (hourly) 510, pay history-salaries 511, payment center 512, payroll management 513, quality assurance 514, rate schedule management 515, system administrator 516, trailer checkers 517 and warehouse truck fees 518.

In one embodiment, the following secondary security functions are provided: for account management 501, invoicing; for attendance management 502, lumping facility; for batch management 503, lumping facility; for data entry 504, open batches; for data entry collections 505, test truck form domains; for data validation 506, test truck form domains; for great plains 507, great plains sales input; for human resources 508, lumping facility; for operations leader 509, lumping facility; for operations leader (hourly) 510, lumping facility; for pay history-salaries 511, lumping facility; for payment center 512, payment center; for payroll management 513, lumping facility; for quality assurance 514, re-bills; for rate schedule management 515, lumping facility; for system administrator 516, tree structure; for trailer checkers 517, lumping facility; and for warehouse truck fees 518, lumping facility/warehouse truck fees. Additionally, tertiary w/sublevels are provided in FIG. 5 under each specific main security block.

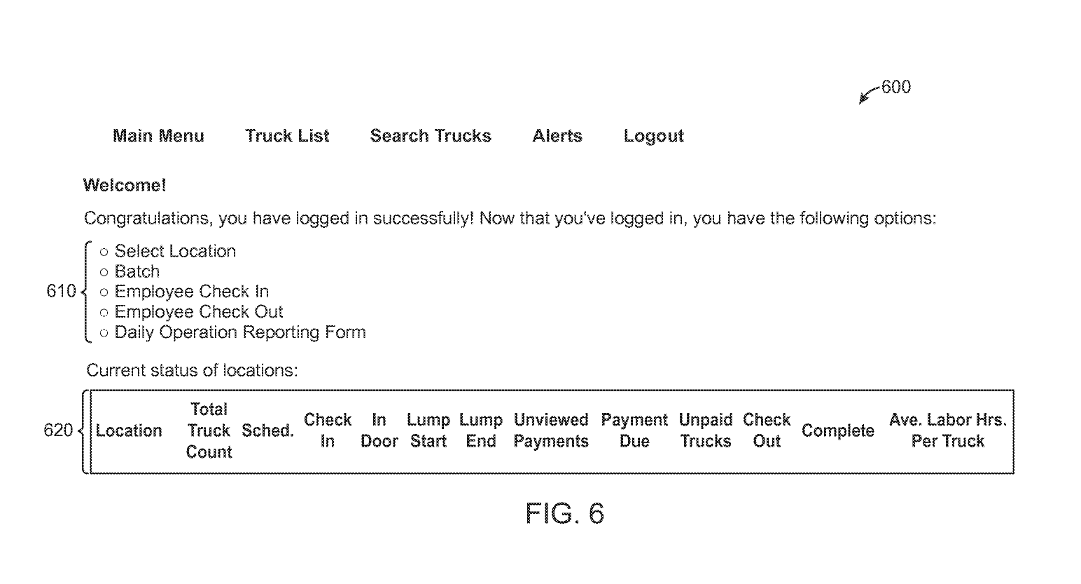

FIG. 6 shows an example web screen 600 for user interaction with the automation system 110, according to an embodiment of the invention. In one example embodiment, the web screen 600 includes options 610 and shows current status of locations 620.

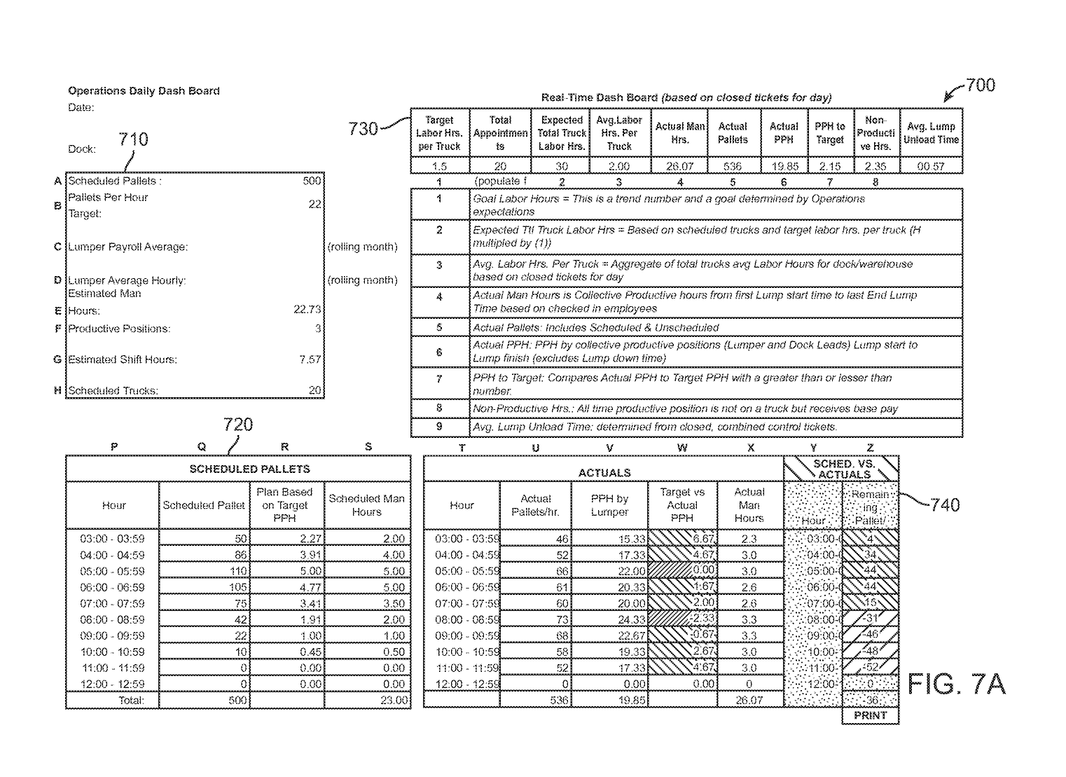

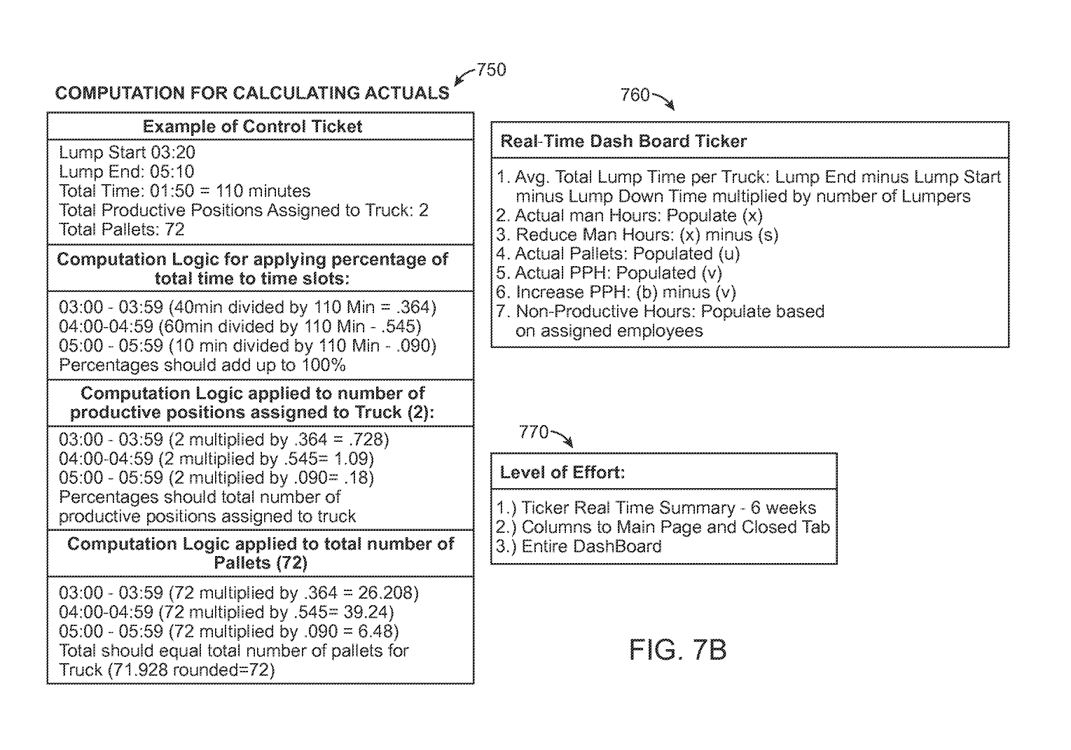

FIGS. 7A-7B show operations real-time daily dashboard 700 with automation, according to an embodiment of the invention. In one example embodiment, in the dock 710 graphical display portion may include the following elements for display:

A) Scheduled pallets:source:populated from a network (e.g., Internet network 130) daily schedule by warehouse—total for the day;

B) Pallets per hour target:source:automated system 110 (TT2);

C) Lumper payroll average:source:automated system 110 (TT2) (e.g., weekly, quarterly, etc.);

D) Lumper average hourly:source:automated system 110 (TT2) (e.g., based on C, e.g., depends on weekly, quarterly, etc.);

E) Estimated man hours: calculated by A divided by B;

F) Productive positions:source:automated system 130 (TT2) (e.g., based on employees checked-in;

G) Estimated shift hours: E divided by F; and

H) Scheduled truck:source:the network, automated system 110 (TT2), etc.

In one example embodiment, the scheduled pallets graphical display portion 720 displays the following graphical elements (note that grid hours match receiving schedule hours):

P) Hour: military labeled time:source:the network (Internet) 130;

Q) Schedule pallets:source:the network (Internet) 130;

R) Plan based on target pallets per hour (PPH): calculated by B divided by Q; and

S) Scheduled man hours: calculated field (rounded down/up), totals: calculated using scheduled pallets and calculated man hours.

In one example embodiment, the real-time dashboard ticker graphical display portion 730 displays the following graphical elements 760 (based on closed tickets for the day):

1) Average total lump time per truck: lump end minus lump start minus lump down time multiplied by the number of lumpers;

2) Actual man hours: populate X (see actual graphical display portion 740);

3) Reduce man hours: X−S;

4) Actual pallets: populated with U;

5) Actual PPH: populated with V;

6) Increase PPH: B minus V; and

7) Non-productive hours: populate based on assigned employees.

In one example embodiment, in the actuals 740 graphical display portion may include the following elements for display:

T) Hour: military label; Source: automated system 110 (TT2);

U) Actual pallets/Hour:source:automated system 110 (TT2) based on lump start and lump end ratio by hour;

V) PPH by lumper:source:automated system 110 (TT2) (collective for checked-in productive positions by dock/warehouse;

W) Target vs. Actual PPH:source:calculated field: V minus B (e.g., Red if less than B, Green if equal to or greater than B;

X) Actual man hours:source:automated system 110 (TT2), ration based on lump start to lump end within hour totals: calculated actual pallets and calculated actual man hours;

Y) Hour: label; and

Z) Remaining pallet/hour: calculated field Q minus U.

In one example embodiment, the summary grid 770 may display the following graphical elements: 1 through 3 are calculated fields based on scheduled versus actual (1: Ticker real-time summary (e.g., 6 weeks, etc.); 2: Columns to main page and closed tab; 3: entire dashboard).

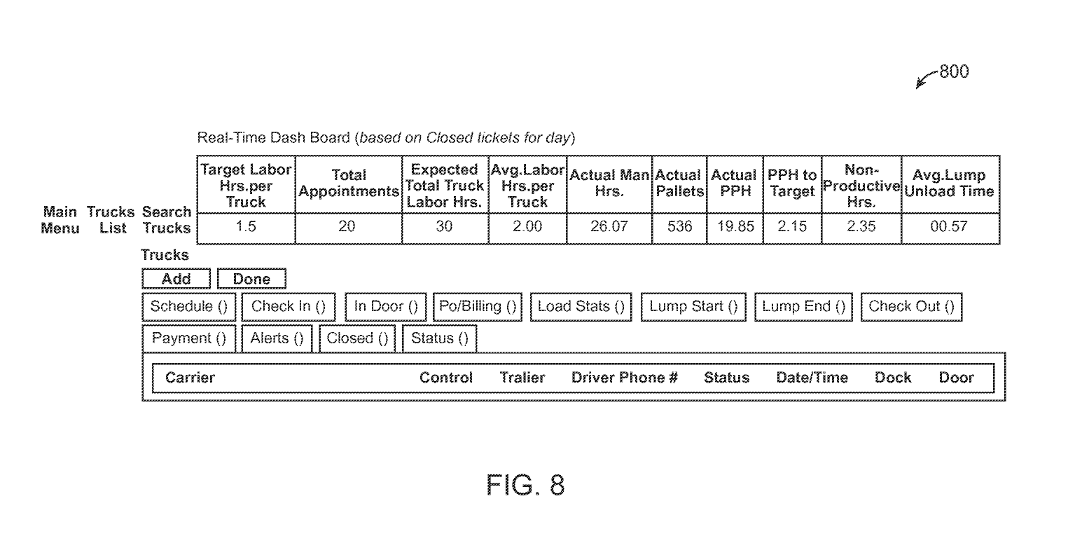

In one example embodiment, elements A-H of the dock 710 graphical display portion populates at the time batch is opened, schedules are loaded and includes employees are checked-in (F). In one embodiment, P through S are loaded at time scheduled and are uploaded, and are based on the plan for the day. In one embodiment, for the actual grid: T through X, these populate with actual information throughout the shift. In one embodiment, for the scheduled versus actual grid: Y (Hour: label) through Z (remaining pallet/hour, populate throughout the shift based on calculating Q minus U. In one embodiment, the computation for calculating actuals 750 provides an example computation shown for a control ticket. In one example embodiment, a ticker is created at the top of each warehouse page, for example, the far right-hand corner of each page. In one example embodiment, the dashboard drills into the truck list header (see FIG. 8), and a PRINT functionality is included on a displayed page and may include different functionalities, print current page, print prior to the close of batch for daily performance, etc. In one embodiment, the ticker may include bells for hours 12:00 through 24:00.

FIG. 8 shows an example display 800 for trucks list option of the web display, according to an embodiment of the invention. In one embodiment, the dashboard ticker is shown on the top-right hand side of the example display. In one embodiment, the truck list display 800 provides information per truck, provides the ability to add trucks, and provides display of other information, such as schedule, check-in, in-door, PO/billing, load stats., lump start, lump end, check-out, payment, alerts, closed, status, etc. In one embodiment, the truck list provides particular truck information, such as carrier, control, trailer, driver telephone number, status, date/time, dock, door, etc.

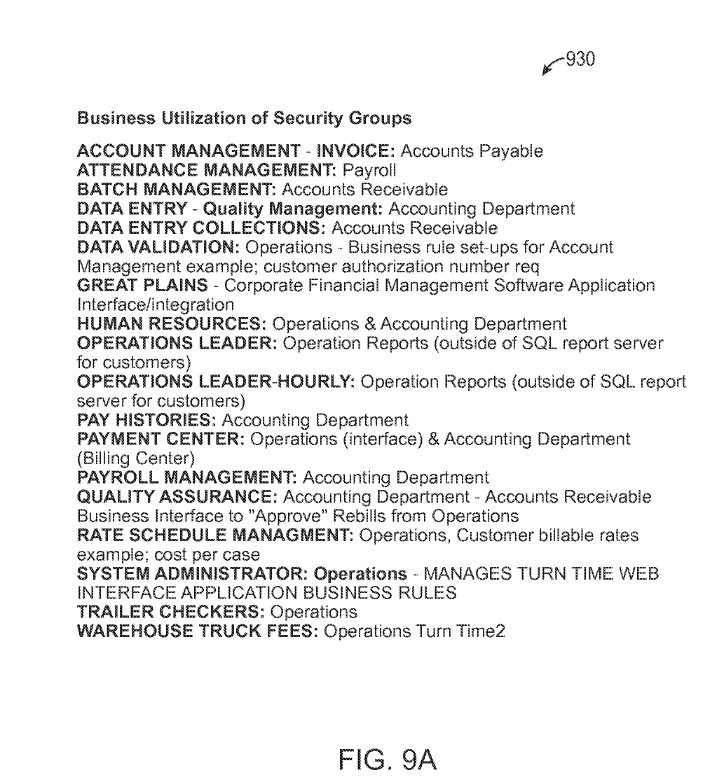

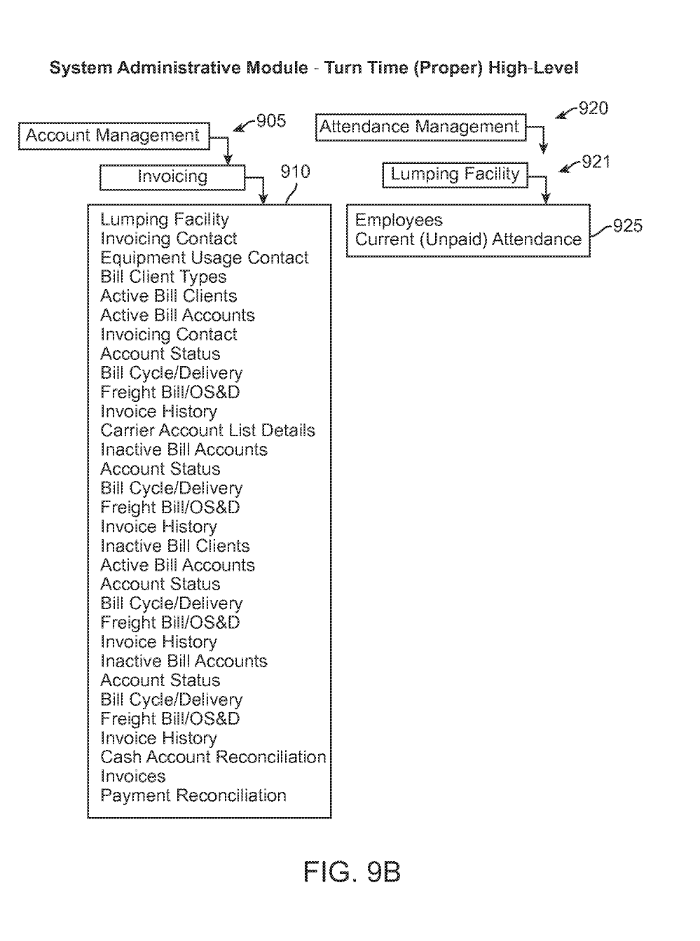

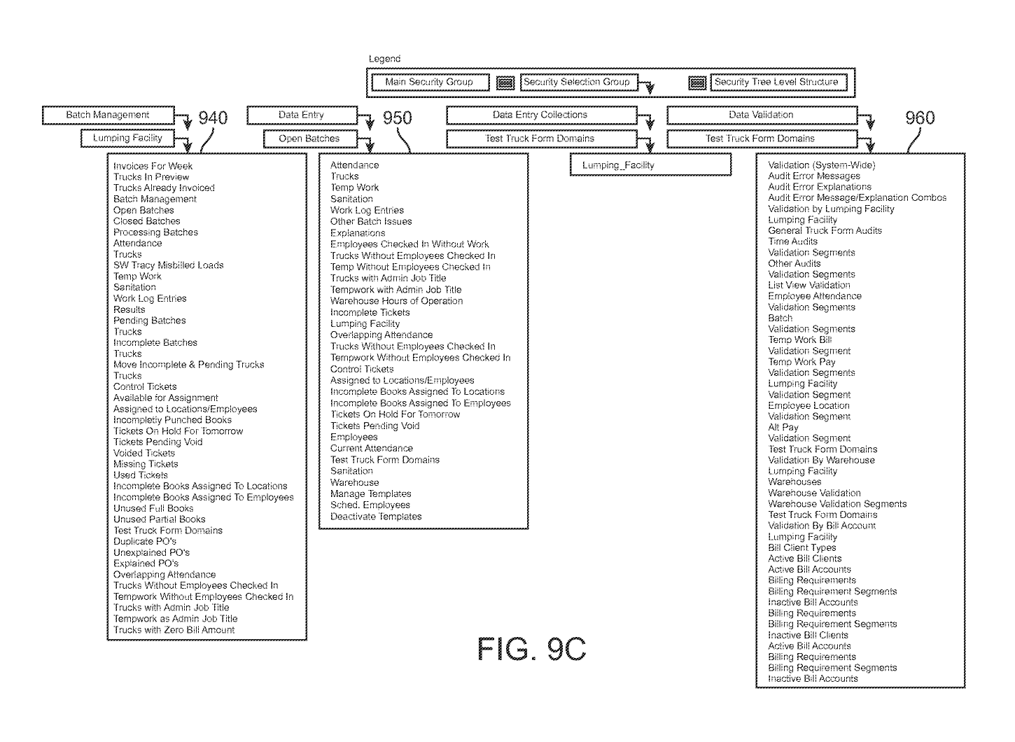

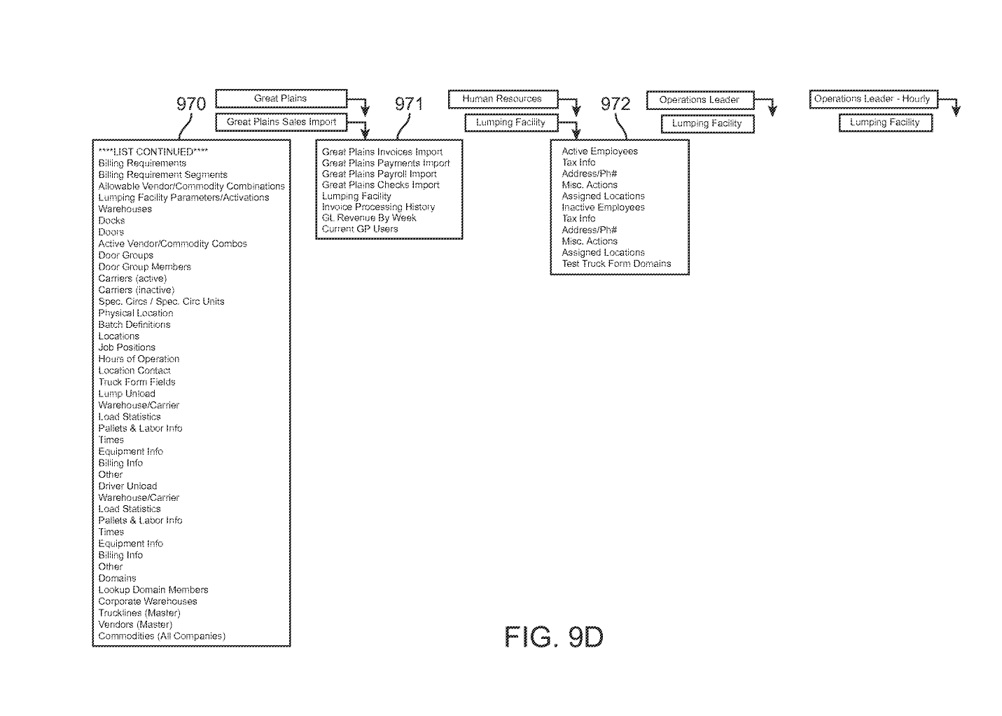

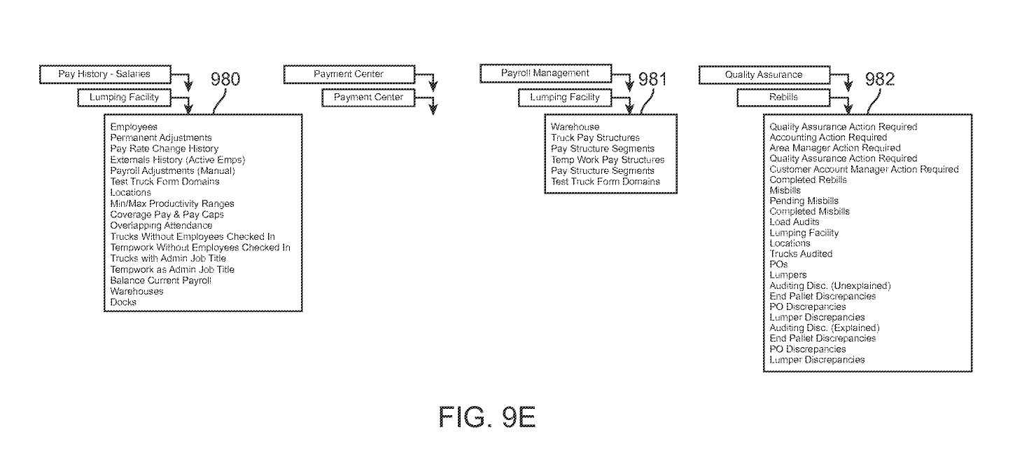

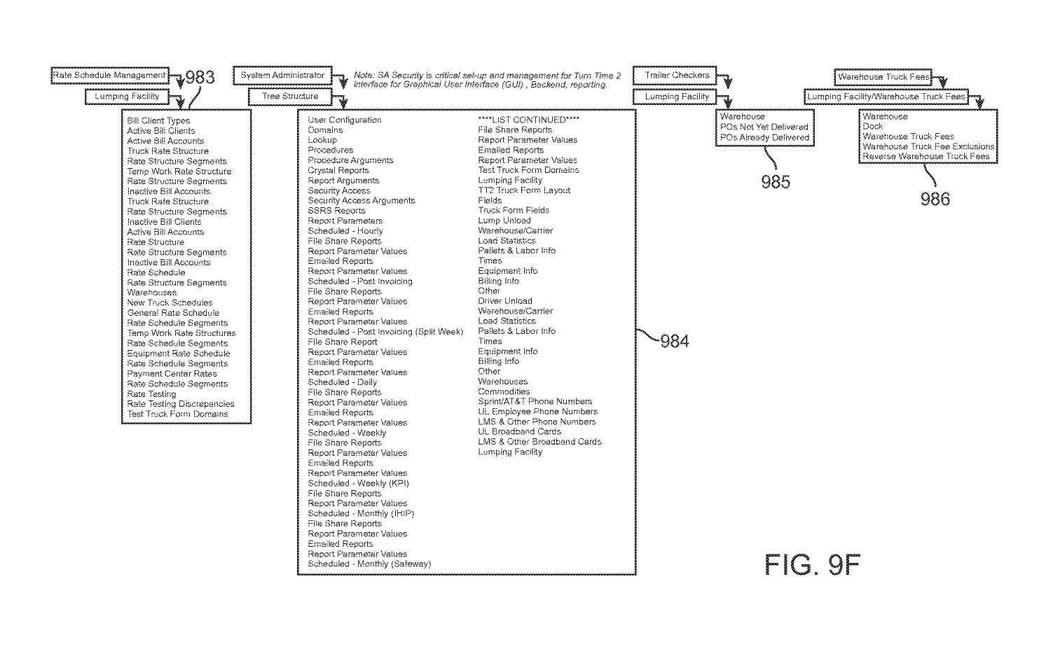

FIGS. 9A-9F show an example structure of system administration for automation, according to an embodiment of the invention. FIG. 9A shows an example structure for business utilization of security groups 930, according to one embodiment.

FIG. 9B shows an example high-level structure for system administrative module for a turn time application used by automated system 110 (FIG. 1), according to one embodiment. In one embodiment, the structure comprises an account management block 905 with invoicing and details 910, and an attendance management block 920 with lumping facility 921 and details 925.

FIG. 9C shows the example structure for a main security group continued and includes a batch management block with lumping facility and details 940, a data entry block with open batches and details 950, a data entry collection block with test truck domains and the lumping facility, a data validation block with test truck form domains and details 960 and 970.

FIG. 9D shows the example structure for a main security group continued and includes a great plains block with great plains sales support and details 971, a human resources block with lumping facility and details 972, an operations leader block and lumping facility, and an operations leader (hourly) and lumping facility.

FIG. 9E shows the example structure for a main security group continued and includes a pay history (salary) block with lumping facility and details 980, a payment center block with a payment facility, a payroll management block, lumping facility and details 981, and a quality assurance block, re-bills and details 982.

FIG. 9F shows the example structure for a main security group continued and includes a rate schedule management block with lumping facility and details 983, a system administrator block with a tree structure and details 984, a trailer checkers block, lumping facility and details 985, and a warehouse truck fees block, lumping facility/warehouse truck fees and details 986.

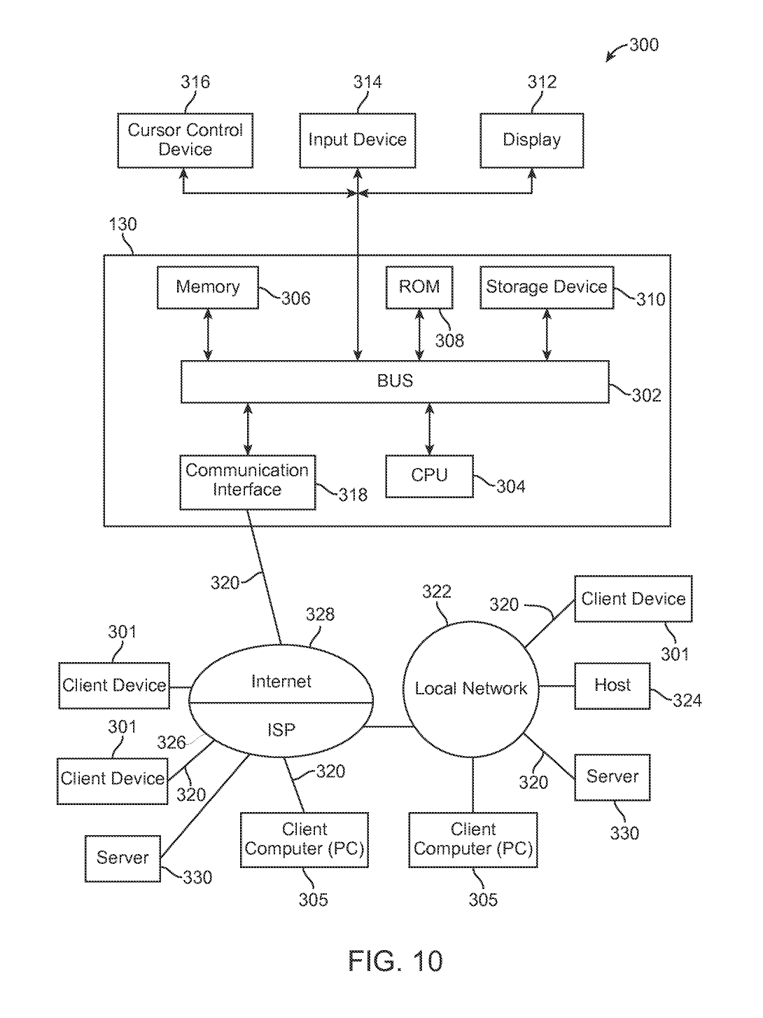

FIG. 10 shows a block diagram of an example system 300 in which an embodiment of the invention may be implemented. In one embodiment, the system 100 (FIG. 1, in part or in whole) may be employed using system 300. In one embodiment, the system 300 includes one or more client devices 301 such as consumer electronics devices, computers, etc., connected to one or more server computing systems 130/330. In one embodiment, a server 130 includes a bus 302 or other communication mechanism for communicating information, and a processor (CPU) 304 coupled with the bus 302 for processing information. The server 130 also includes a main memory 306, such as a random access memory (RAM) or other dynamic storage device, coupled to the bus 302 for storing information and instructions to be executed by the processor 304. The main memory 306 also may be used for storing temporary variables or other intermediate information during execution or instructions to be executed by the processor 304. In one embodiment, the database 114 (FIG. 1) may use the main memory 306, or an internal/external memory device or storage system.

The server computer system 130 further includes a read only memory (ROM) 308 or other static storage device coupled to the bus 302 for storing static information and instructions for the processor 304. A storage device 310, such as a magnetic disk or optical disk, is provided and coupled to the bus 302 for storing information and instructions. The bus 302 may contain, for example, thirty-two address lines for addressing video memory or main memory 306. The bus 302 can also include, for example, a 32-bit data bus for transferring data between and among the components, such as the CPU 304, the main memory 306, video memory and the storage 310. Alternatively, multiplex data/address lines may be used instead of separate data and address lines.

The server 130 may be coupled via the bus 302 to a display 312 for displaying information to a computer user. An input device 314, including alphanumeric and other keys, is coupled to the bus 302 for communicating information and command selections to the processor 304. Another type or user input device comprises cursor control 316, such as a mouse, a trackball, or cursor direction keys for communicating direction information and command selections to the processor 304 and for controlling cursor movement on the display 312.

According to one embodiment of the invention, the functions of the invention are performed by the processor 304 executing one or more sequences of one or more instructions contained in the main memory 306. Such instructions may be read into the main memory 306 from another computer-readable medium, such as the storage device 310. Execution of the sequences of instructions contained in the main memory 306 causes the processor 304 to perform the process steps described herein. One or more processors in a multi-processing arrangement may also be employed to execute the sequences of instructions contained in the main memory 306. In alternative embodiments, hard-wired circuitry may be used in place of or in combination with software instructions to implement the invention. Thus, embodiments of the invention are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 304 for execution. Such a medium may take many forms, including but not limited to, non-volatile media, volatile media, and transmission media. Non-volatile media includes, for example, optical or magnetic disks, such as the storage device 310. Volatile media includes dynamic memory, such as the main memory 306. Transmission media includes coaxial cables, copper wire and fiber optics, including the wires that comprise the bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 304 for execution. For example, the instructions may initially be carried on a magnetic disk of a remote computer. The remote computer can load the instructions into its dynamic memory and send the instructions over a telephone line using a modem. A modem local to the server 330 can receive the data on the telephone line and use an infrared transmitter to convert the data to an infrared signal. An infrared detector coupled to the bus 302 can receive the data carried in the infrared signal and place the data on the bus 302. The bus 302 carries the data to the main memory 306, from which the processor 304 retrieves and executes the instructions. The instructions received from the main memory 306 may optionally be stored on the storage device 310 either before or after execution by the processor 304.

The server 130 also includes a communication interface 318 coupled to the bus 302. The communication interface 318 provides a two-way data communication coupling to a network link 320 that is connected to the world wide packet data communication network now commonly referred to as the Internet 328. The Internet 328 uses electrical, electromagnetic or optical signals that carry digital data streams. The signals through the various networks and the signals on the network link 320 and through the communication interface 318, which carry the digital data to and from the server 330, are exemplary forms or carrier waves transporting the information.

In another embodiment of the server 330, interface 318 is connected to a network 322 via a communication link 320. For example, the communication interface 318 may be an integrated services digital network (ISDN) card or a modem to provide a data communication connection to a corresponding type of telephone line, which can comprise part of the network link 320. As another example, the communication interface 318 may be a local area network (LAN) card to provide a data communication connection to a compatible LAN. Wireless links may also be implemented. In any such implementation, the communication interface 318 sends and receives electrical electromagnetic or optical signals that carry digital data streams representing various types of information.

The network link 320 typically provides data communication through one or more networks to other data devices. For example, the network link 320 may provide a connection through the local network 322 to a host computer 324 or to data equipment operated by an Internet Service Provider (ISP) 326. The ISP 326 in turn provides data communication services through the Internet 328. The local network 322 and the Internet 328 both use electrical, electromagnetic or optical signals that carry digital data streams. The signals through the various networks and the signals on the network link 320 and through the communication interface 318, which carry the digital data to and from the server 330, are exemplary forms or carrier waves transporting the information.

The server 330 can send/receive messages and data, including e-mail, program code, through the network, the network link 320 and the communication interface 318. Further, the communication interface 318 can comprise a USB/Tuner and the network link 320 may be an antenna or cable for connecting the server 330 to a cable provider, satellite provider or other terrestrial transmission system for receiving messages, data and program code from another source.

The example embodiments of the invention described herein may be implemented as logical operations in a distributed processing system such as the system 300 including the servers 330. The logical operations of the present invention may be implemented as a sequence of steps executing in the server 330, and as interconnected machine modules within the system 300. The implementation is a matter of choice and can depend on performance of the system 300 implementing the invention. As such, the logical operations constituting said example versions of the invention are referred to for e.g., as operations, steps or modules.

Similar to a server 330 described above, a client device 301 may include a processor, memory, storage device, display, input device and communication interface (e.g., e-mail interface) for connecting the client device to the Internet 328, the ISP 326, or LAN 322, for communication with the servers 330.

The system 300 can further include computers (e.g., personal computers, computing nodes) 305 operating in the same manner as client devices 301, wherein a user can utilize one or more computers 305 to manage data in the server 330.

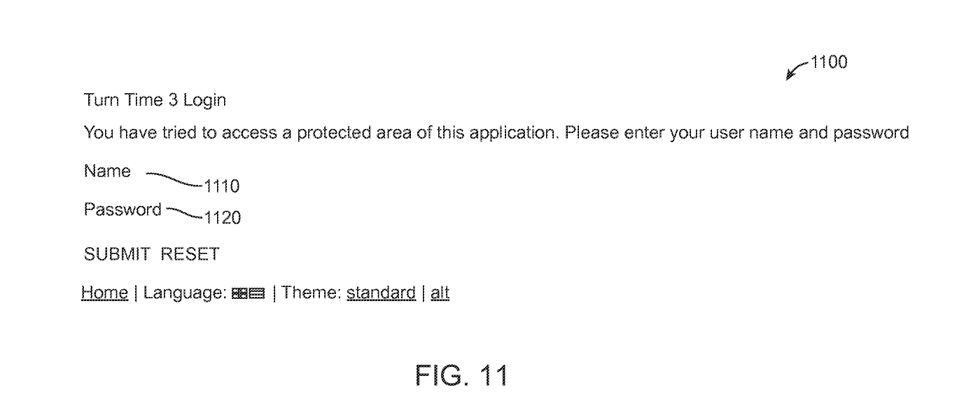

FIG. 11 shows an example administration log-in interface 1100 for access to a summary dashboard (e.g., a Turn Time 3 (TT3) summary dashboard/PayLump summary dashboard), according to an embodiment of the invention.

In one embodiment, the summary dashboard may use a modified automated system 110 (TT2), which may be known as TT3 or PayLump. In one embodiment, the dashboard security is integrated with windows active directory (AD). In one embodiment, the user logs-in using the interface 1100 and enters a user name 1110 and a password 1120.

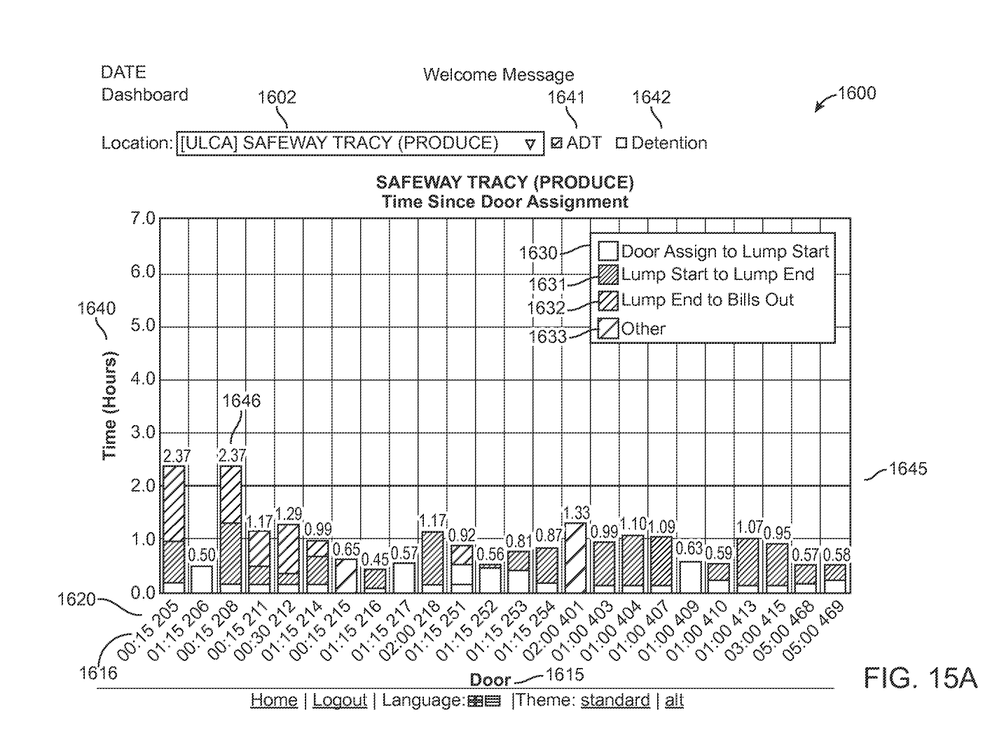

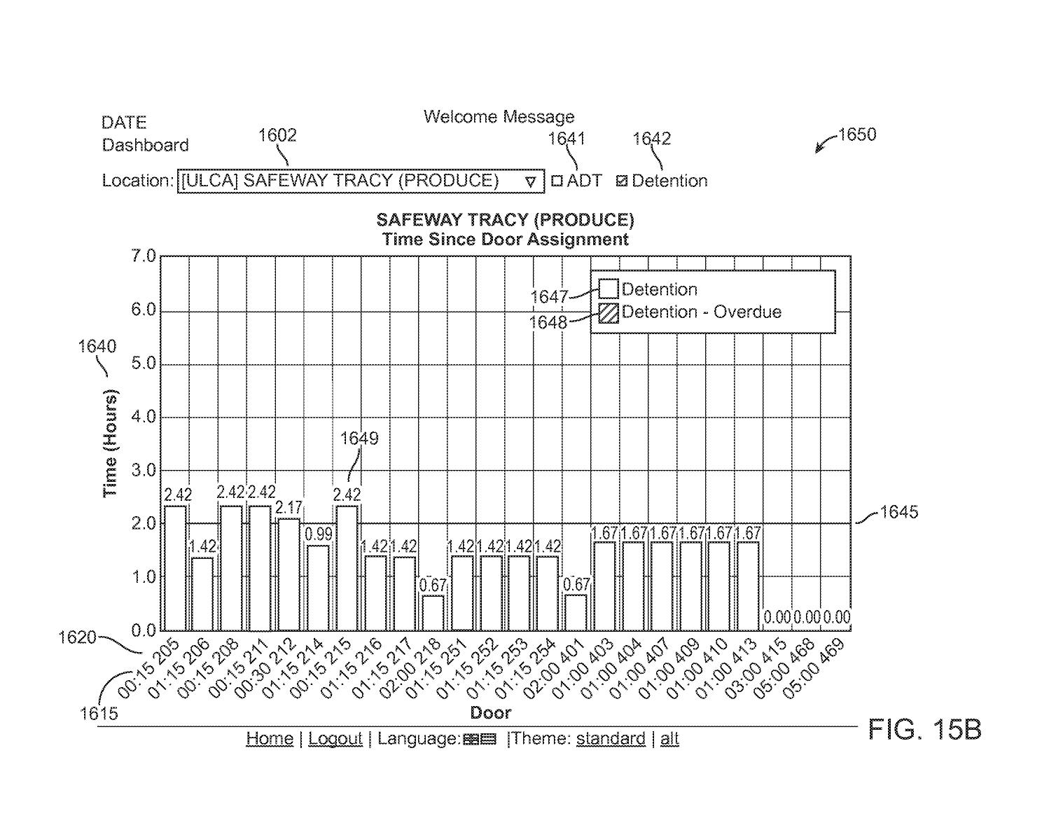

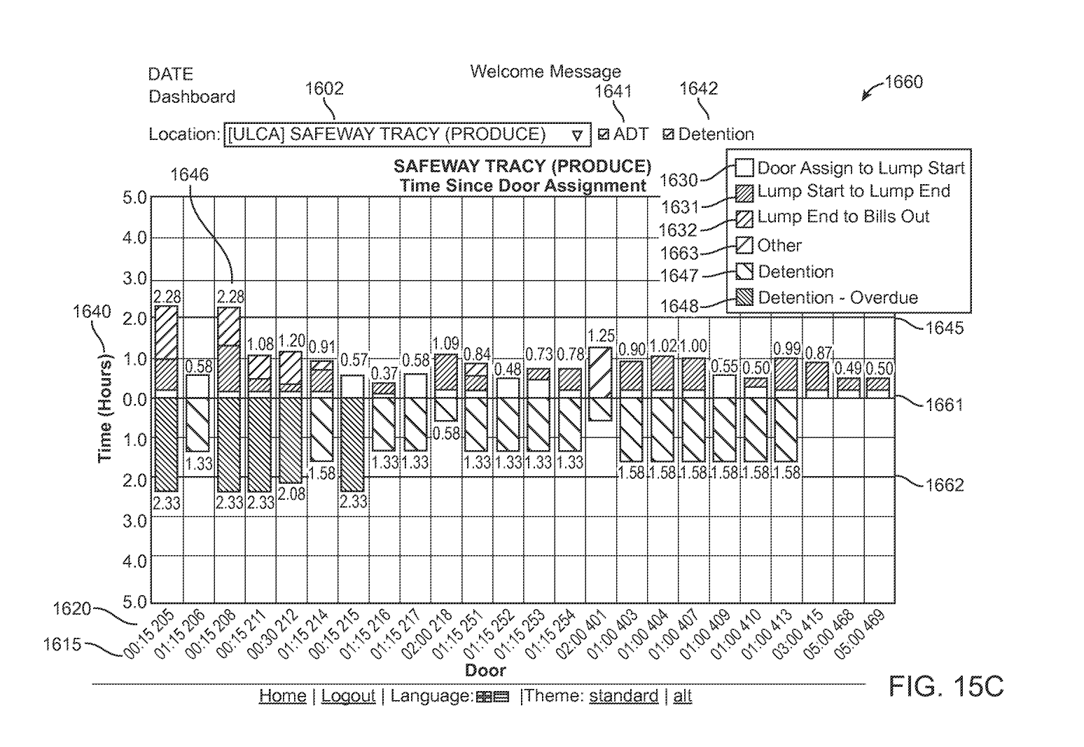

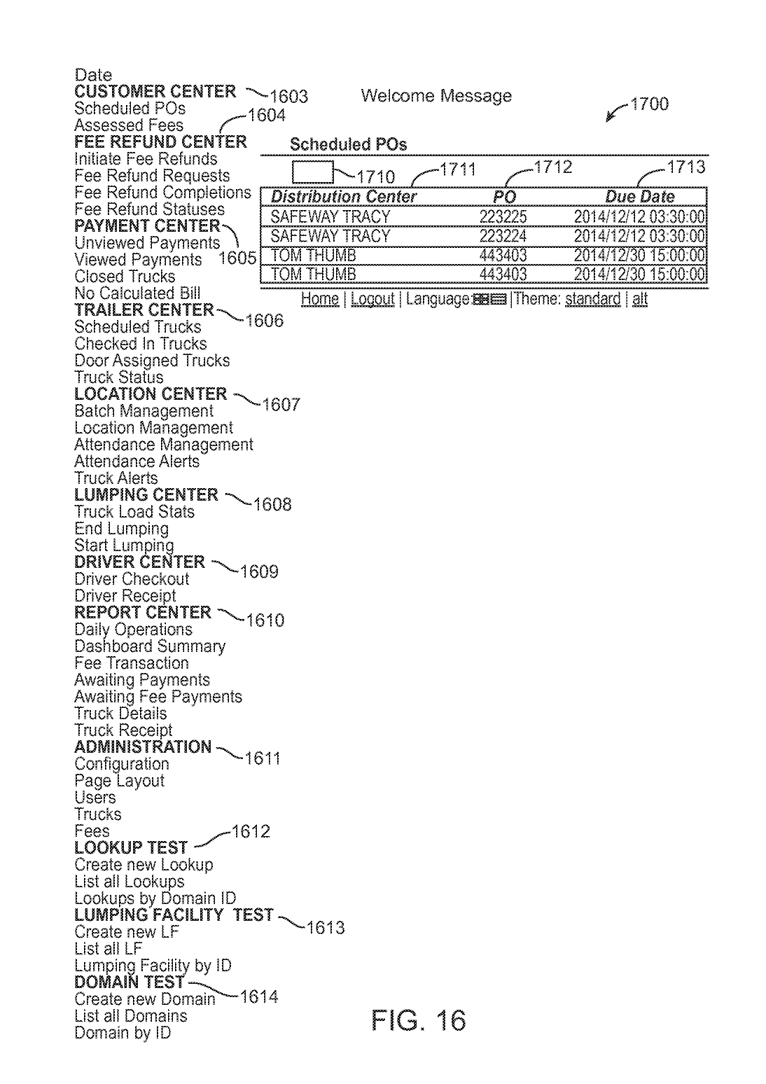

In one embodiment, the user or customer may desire to view a summary down to the dock (location) level. In one embodiment, the dashboard (e.g., FIGS. 15A-C) is designed to provide a summary view down to the dock (location) level of a customer distribution center and warehouse within a distribution center. In one embodiment, the summary view provides an “at a glance” display of an entire receiving location during uploading of customer purchase orders from each and every delivery truck.

In one embodiment, the dashboard summary “real-time report” comprises a bar graph display of each location door. In one embodiment, a door display bar is activated by the truck door assignment and extends through the customer PO receiving process to the time that the truck bills are provided back to the driver. In one embodiment, truck and PO unload information is recorded at the “point-of-sale”in the UL proprietary web application TT2 as the truck unload takes place.

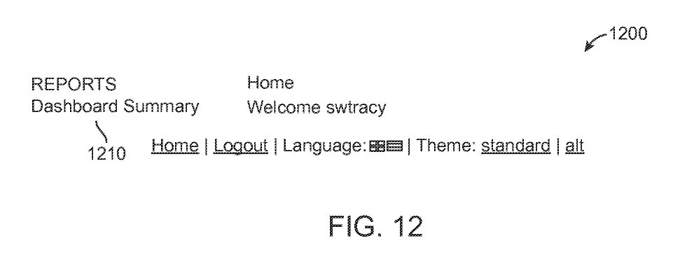

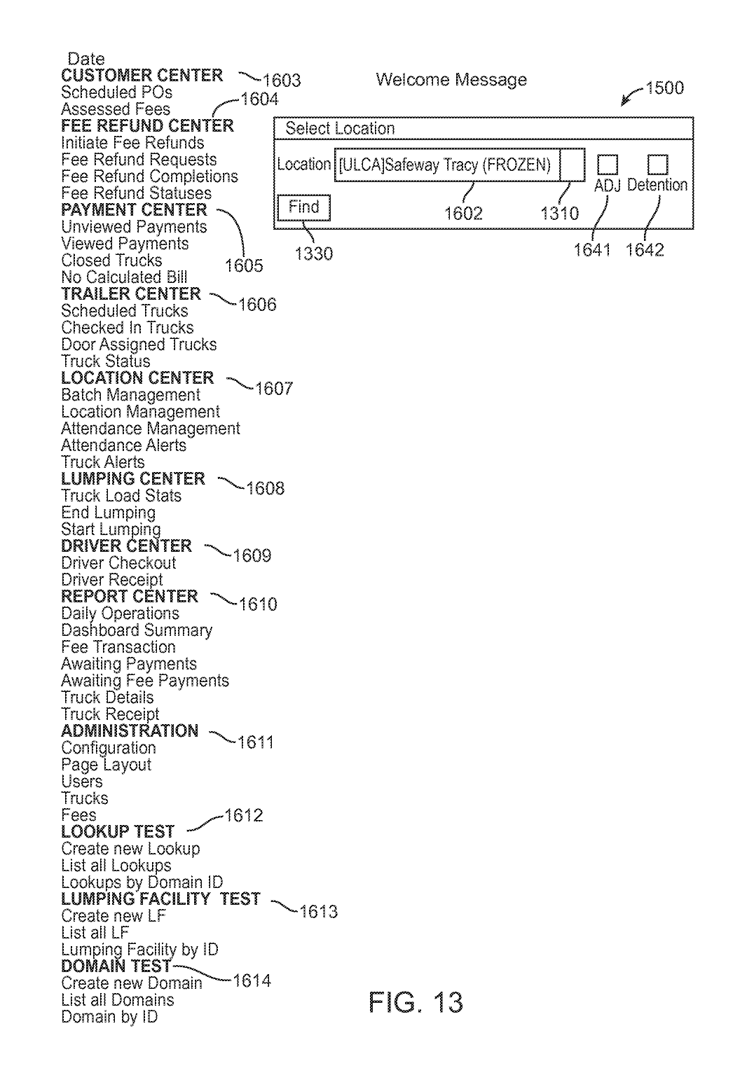

FIG. 12 shows an example administration entry interface 1200 for the summary selection, according to an embodiment of the invention. In one embodiment, from the administration entry interface 1200 a user may select the dashboard summary selection link 1210 under the reports selection list.

FIG. 13 shows an example location selection and type of summary dashboard selection interface 1500, according to an embodiment of the invention. In one embodiment, the location selection and type of summary dashboard selection interface 1500 includes a location selection menu 1310, a type of summary dashboard selections including ADT selection 1641 and detention selection 1642, and a find button 1330 that enters the selected information into the system for a custom view display for the summary dashboard. In one embodiment, the selected location 1602 is displayed in the location selection menu 1310 once selected.

In one example embodiment, information may be retrieved for various selections on the left-hand side of the interface 1500 page. In one embodiment, different categorized information may be retrieved from the selections, including the following categories: customer center 1603 (e.g., scheduled POs, assessed fees), fee refund center 1604 (e.g., initiate fee refunds, fee refund requests, fee refund completions, fee refund statuses), payment center 1605 (e.g., unviewed payments, viewed payments, closed trucks, no calculated bill), trailer center 1606 (scheduled trucks, checked-in trucks, door assigned trucks, truck status), location center 1607 (e.g., batch management, location management, attendance management, attendance alerts, truck alerts), lumping center 1608 (e.g., truck load stats, end lumping, start lumping), driver center 1609 (e.g., driver checkout, driver receipt), report center 1610 (e.g., daily operations, dashboard summary, fee transaction, awaiting payments, awaiting fee payments, truck details, truck receipt), administration 1611 (e.g., configuration, page layout, users, trucks, fees), lookup test 1612 (e.g., create new lookup, list all lookups, lookup by domain ID), lumping facility test 1613 (e.g., create new LF (Lumping facility), list all LF, lumping facility by ID), and Domain test 1614 (e.g., create new domain, list all domains, domain by ID), etc. In one example embodiment, more or less categories and selections under each category may be displayed (e.g., depending on authorization, access requirement, type of user, etc.).

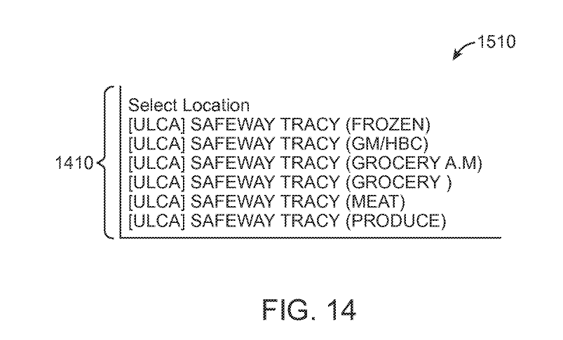

FIG. 14 shows an example location selection interface 1510 for the summary dashboard, according to an embodiment of the invention. In one embodiment, the locations 1410 are displayed for selection from a dropdown menu, a list, etc. Once a location 1602 is selected, the location 1602 is shown in the location selection menu 1310.

FIGS. 15A-C show example summary dashboards, according to an embodiment of the invention. In one embodiment, the tolerance is set for a predetermined number of hours. In one example, the summary dashboards have a set tolerance of 2 hours. In other embodiments, the set tolerance may be pre-set to other defaults, such as 2 hours, 3 hours, etc. In one embodiment, as shown in FIG. 15A, an example summary dashboard 1600 is generated for the Active Door Time (ADT) (or receiving compliance) selection 1641. The location 1602 is already set (e.g., Safeway Tracy (Produce). The checkmark for ADT is selected. In one embodiment, each bar on the dashboard represents a truck unload taking place at an assigned door 1615 (e.g., doors 1620) in the chosen warehouse location 1602 and the bars comprise of one or more components. In one embodiment example, the components are color coded and are contiguous on the display. In one embodiment, the entire bar represents the ADT 1616 for each door assignment at the receiving dock.

In one embodiment, below each bar is the door assignment 1620 and truck scheduled time 1616. In one embodiment, if a truck is late for a scheduled appointment, the truck scheduled time 1616 is appended with an indicator, such as “−L” indicating late arrival. In one embodiment, the door assignment 1615 is on the x-axis of the bar graph, and total ADT 1640 (in hours) extends along the y-axis. In one embodiment, time is capped at 7 hours to provide a limited view of trucks with extended door time. In one embodiment, ADT 1616 continues to extend as the door time extends.

In one embodiment a line 1645 is placed at 2 hours ADT. In one embodiment, the line 1645 may be indicated as colored line (e.g., red). In one embodiment, the color coded line 1645 on the bar graph provides a quick reference to trucks approaching the receiving compliance threshold and extending beyond that threshold.

In one embodiment, bar graphs have codes (e.g., color codes) to signify different times. In one embodiment, a first code 1630 indicates the door assign to lump start time; a second code 1631 indicates the lump start to lump end time; a third code 1632 indicates lump end to bills out time; and a fourth code 1633 indicates other times (e.g., dropped, backhauls, driver unloads, etc.). In one embodiment, an indication 1646 indicates the time a truck has been in the door from a door assignment.

In one embodiment, the codes 1630, 1631, 1632 and 1633 are each assigned a different color. In one example, code 1630 may be assigned orange, code 1631 may be assigned blue, code 1632 may be assigned brown and the fourth code 1633 may be assigned black.

In one embodiment, unload details are provided for each truck unload in the form of an information bubble (or pop-up display) activated by hovering over the chosen bar (e.g., with a mouse curser, a finger, etc.). In one example embodiment, the information bubble may include bar segment time, lump down time (if any), vendor name, customer efficiency vendors (if any), carrier, PO(s), truck labor type, lump complete indicator, driver unload information, dropped and/or backhaul for other category (black bar segment), etc.

FIG. 15B shows an example summary dashboard 1650 is generated for the Detention selection 1642. The location 1602 is already set (e.g., Safeway Tracy (Produce). The checkmark for detention is selected. In one embodiment, the summary dashboard 1650 has similar features as the summary dashboard 1600 with several differences. In one embodiment, the summary dashboard 1650 has two codes, which may be color-coded that represent detention in tolerance 1647 and detention overdue (out of tolerance) 1648. In one example, the code 1647 may have a first color (e.g., green) and the code 1648 may have a second color (e.g., red). The zero line on the display represents the scheduled time in the Detention display while representing door assignment time in the ADT display. The time 1649 indicates total time in hours and minutes.

FIG. 15C shows an example summary dashboard 1660 is generated for the ADT selection 1641 and the Detention selection 1642. The location 1602 is already set (e.g., Safeway Tracy (Produce). The checkmark for ADT and detention are selected. In one embodiment, the summary dashboard 1660 has similar features as the summary dashboard 1600 and 1650, which are now combined into a single view. In one embodiment, the summary dashboard 1660 has the codes 1630, 1631, 1632, 1633 1647 and 1648. The zero line 1661 separates the ADT and detention bar graphs. The line 1662 represents the two (2) hour mark on the detention portion of the summary dashboard 1660.

In one embodiment, internal and external alerts based on the ADT and/or detention tolerance zones for significant times (e.g., 1.5 hours, 2.0 hours, 2.5 hours, etc.) may be sent using alert messages (e.g., email, text messages, pages, telephone calls, etc.). In one embodiment, internal and external alerts based on the lump down start times may be sent using alert messages. In one embodiment, an internal dashboard ticker may be displayed to provide unload stats on a real-time basis. In one embodiment, the internal dashboard ticker may be displayed through an application or app on a smart device, cell phone, a tablet, a wearable device, etc., and/or on a webpage, etc.

In one embodiment, incorporation of distribution center view to include checked-in trucks awaiting door assignment and doors available may be displayed on the dashboard summary interfaces (e.g., 1600, 1650, 1660), other webpage, etc. In one embodiment, incorporation of scheduled appointment times in distribution center view may be displayed on the different dashboard interfaces, other webpages, apps, etc.

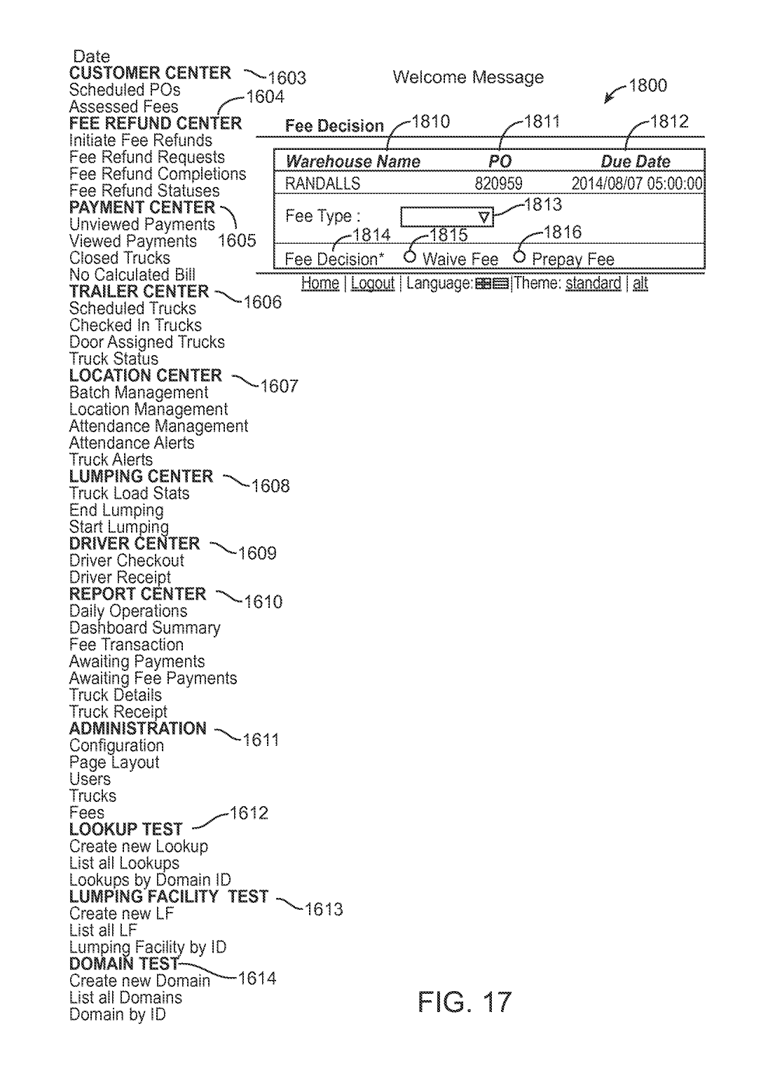

FIG. 16 shows an example view of a scheduled PO interface 1700, according to an embodiment of the invention. In one embodiment, various information may be included in the scheduled PO interface 1700, including distribution center 1711, PO 1712, due date 1713, etc. In one embodiment, additional unscheduled POs may be dynamically added using the add selection 1710. In one embodiment, the scheduled PO interface 1700 shows a selected PO(s) for fee waiver or fee prepayment.

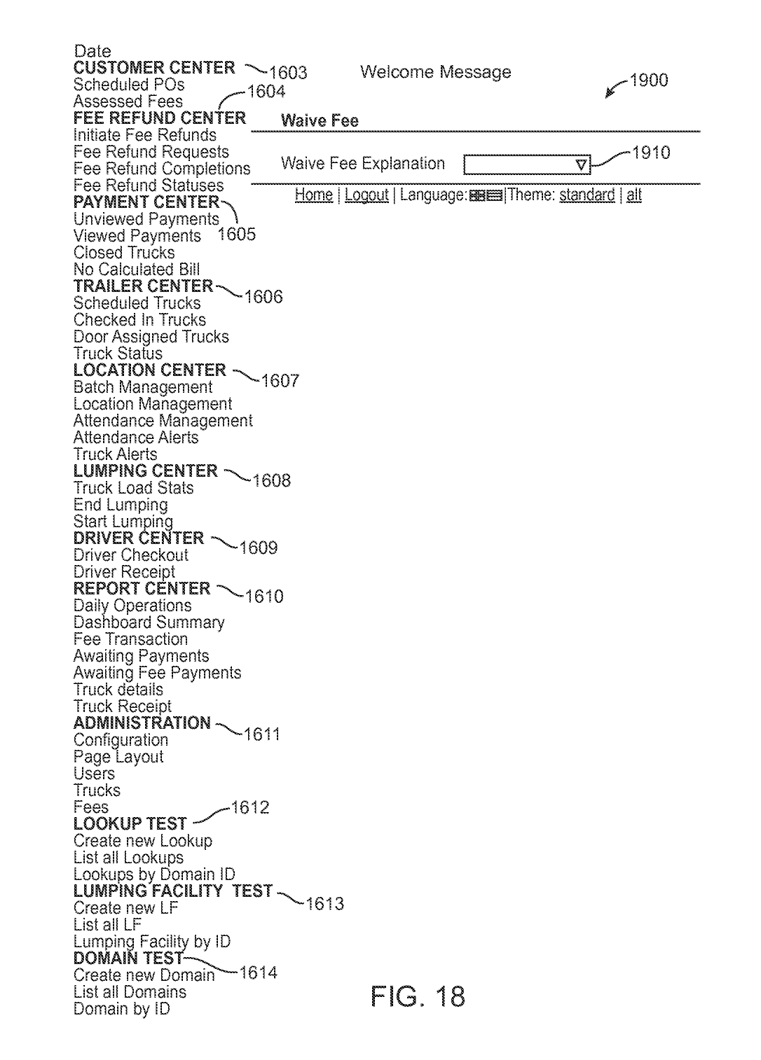

FIG. 17 shows an example view of a scheduled PO fee decision interface 1800, according to an embodiment of the invention. In one embodiment, various information may be included in the scheduled PO fee decision interface 1800, including warehouse name 1810, PO 1811, due date 1812, etc. After selecting a PO 1712 to process in the schedule PO interface 1700, the user is prompted for the fee type 1813 and fee decision 1814 for the case where they want to waive the fee 1815 or prepay the fee 1816 in the scheduled PO fee decision interface 1800.

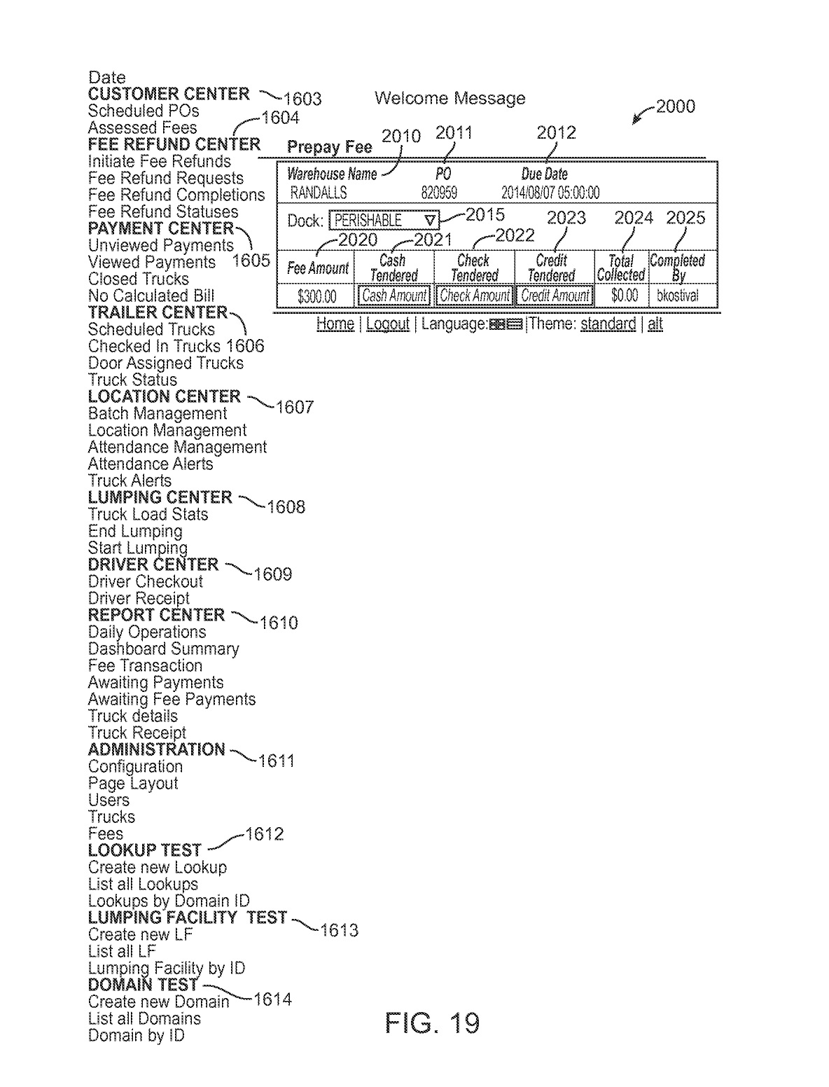

FIG. 18 shows an example view of a scheduled PO waive fee interface 1900, according to an embodiment of the invention. In one embodiment, the scheduled PO waive fee interface 1900 shows the prompt for waive reason 1910 on a fee waiver request. In one example embodiment, the waive fee reason 1910 may include Warehouse Approved, Carrier Change, LTL and Mechanical.

FIG. 19 shows an example view of a scheduled PO prepay fee interface 2000, according to an embodiment of the invention. In one embodiment, various information may be included in the scheduled PO prepay fee interface 2000, including warehouse name 2010, PO 2011, due date 2012, etc. The prompts for scheduled PO prepay requests may include fee amount 2020, cash tendered 2021, check tendered 2022, credit tendered 2023, total collected 2024, completed by 2025, etc. The dock type 2015 is also selectable (e.g., perishable, nonperishable, etc.).

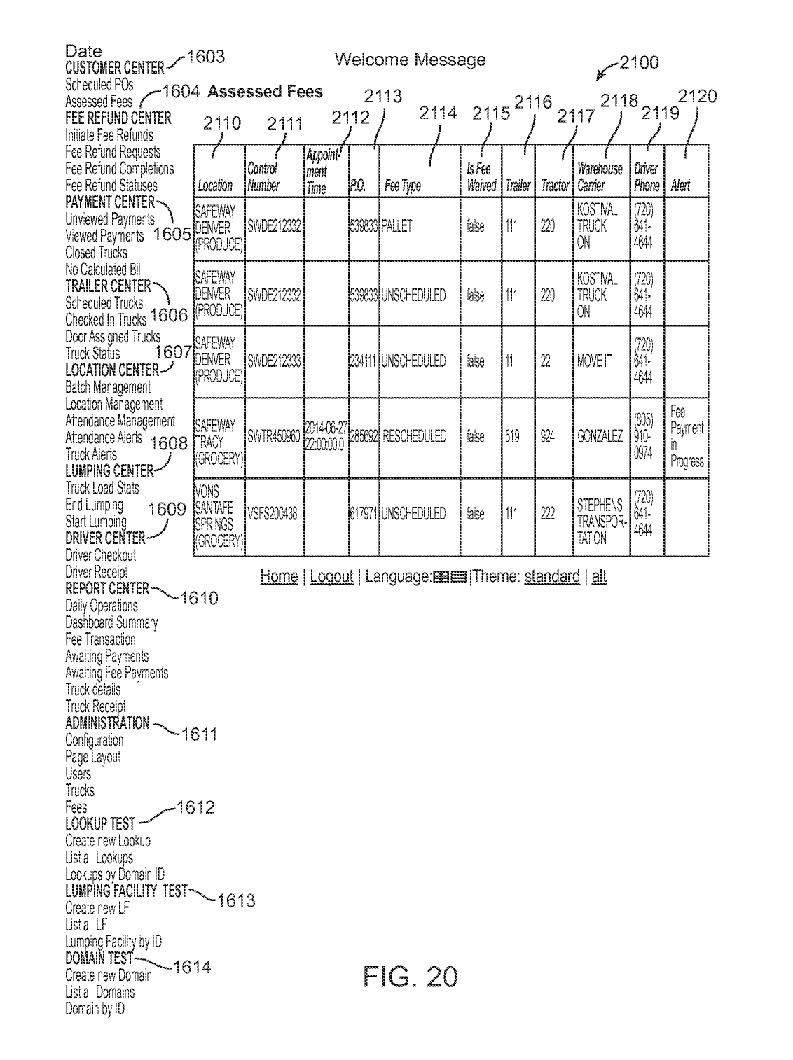

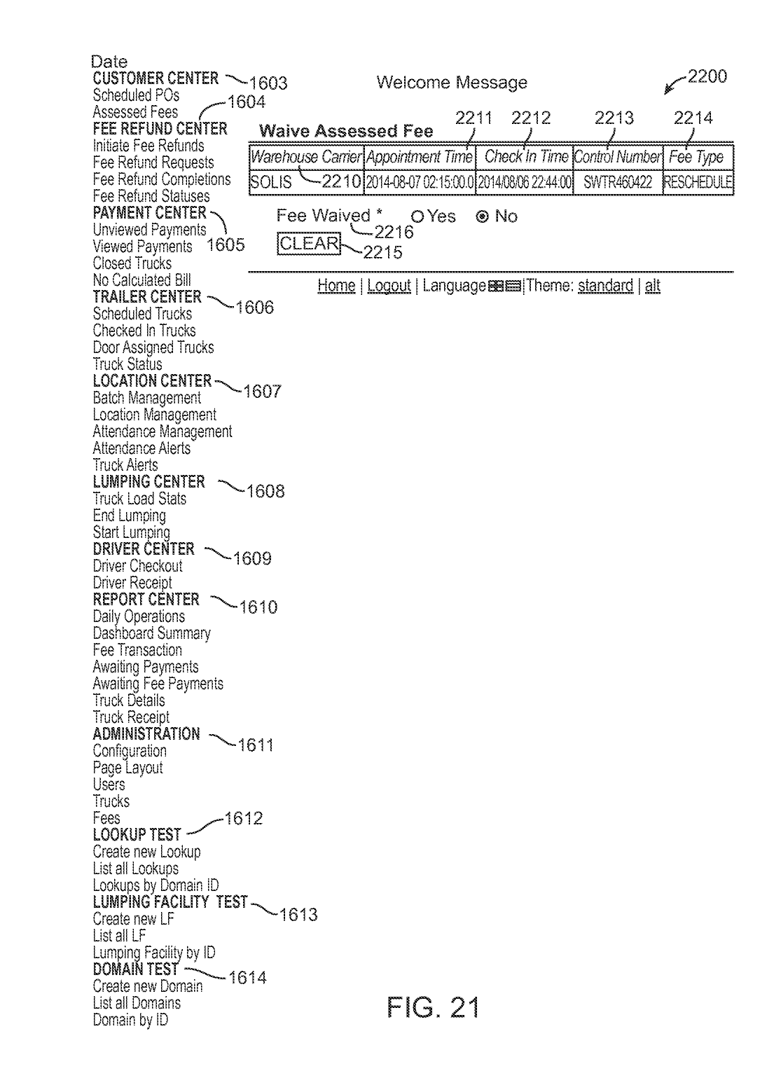

FIG. 20 shows an example view of assessed fees 2100, according to an embodiment of the invention. In one embodiment, various information may be dynamically displayed for the assessed fee view 2100, such as location 2110, control number 2111, appointment time 2112, PO 2113, fee type 2114, is the fee waived 2115, trailer 2116, tractor 2117, warehouse carrier 2118, driver phone number 2119, alert 2120, etc. In one embodiment, the assessed fees view is used to select a PO for fee waiver after fee assessment in a currently open receiving batch (in real-time).

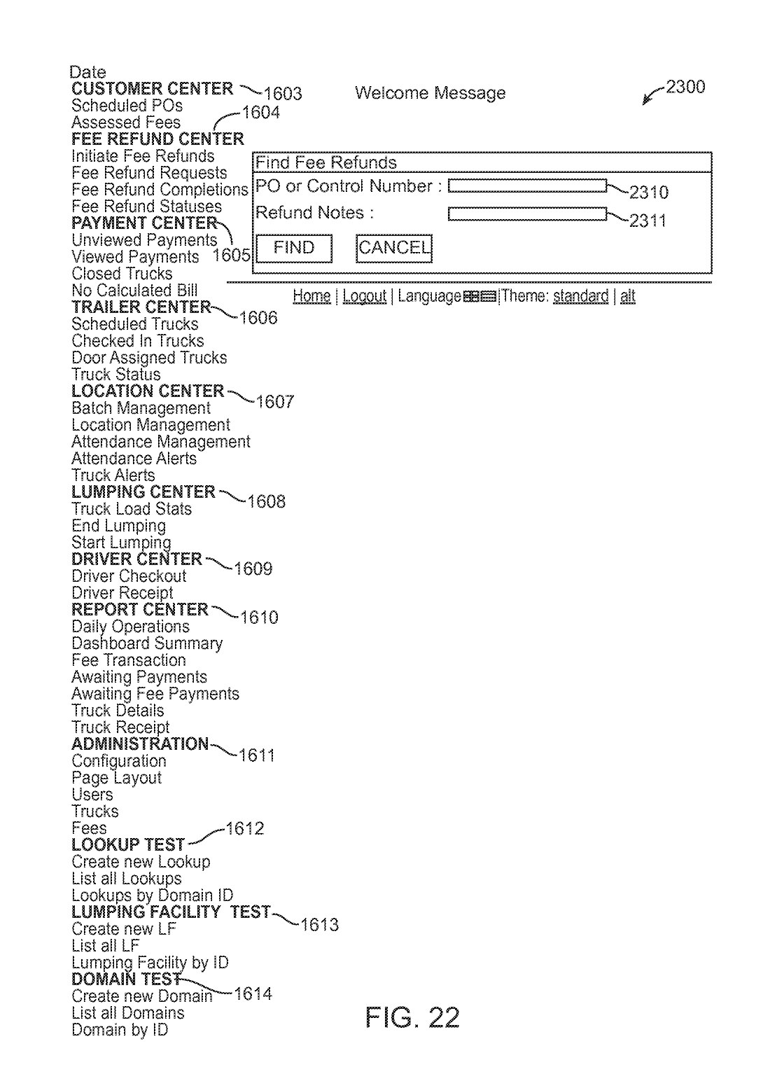

FIG. 21 shows an example view of assessed fee waive interface 2200, according to an embodiment of the invention. In one embodiment, the assessed fee waive interface 2200 includes various dynamic information, such as warehouse carrier 2210, appointment time 2211, check in time 2212, control number 2213, fee type 2214, etc. In one embodiment, after PO selection in the assessed fees view 2100, the user is prompted to waive select whether the fee is waived or not using the waive yes no selections 2216. After the selection to waive is made, entry of clear 2215 enters the selection.

FIG. 22 shows an example view of an initiate refund interface 2300, according to an embodiment of the invention. In one embodiment, the user is prompted for the PO or control number 2310 and refund notes 2311. In one embodiment, customers may initiate refunds of fees of any fee assessed and paid in the system. In one embodiment, the refund begins with initiation shown in the initiate refund interface 2300. In one embodiment, if the PO or control number entry 2310 returns a fee, the user is prompted to initiate the refund and provide notes 2311 for refund processing. In one embodiment, the initiated refund requests are dynamically (e.g., automatically) processed based on the user initiated entry using the initiate refund interface 2300.

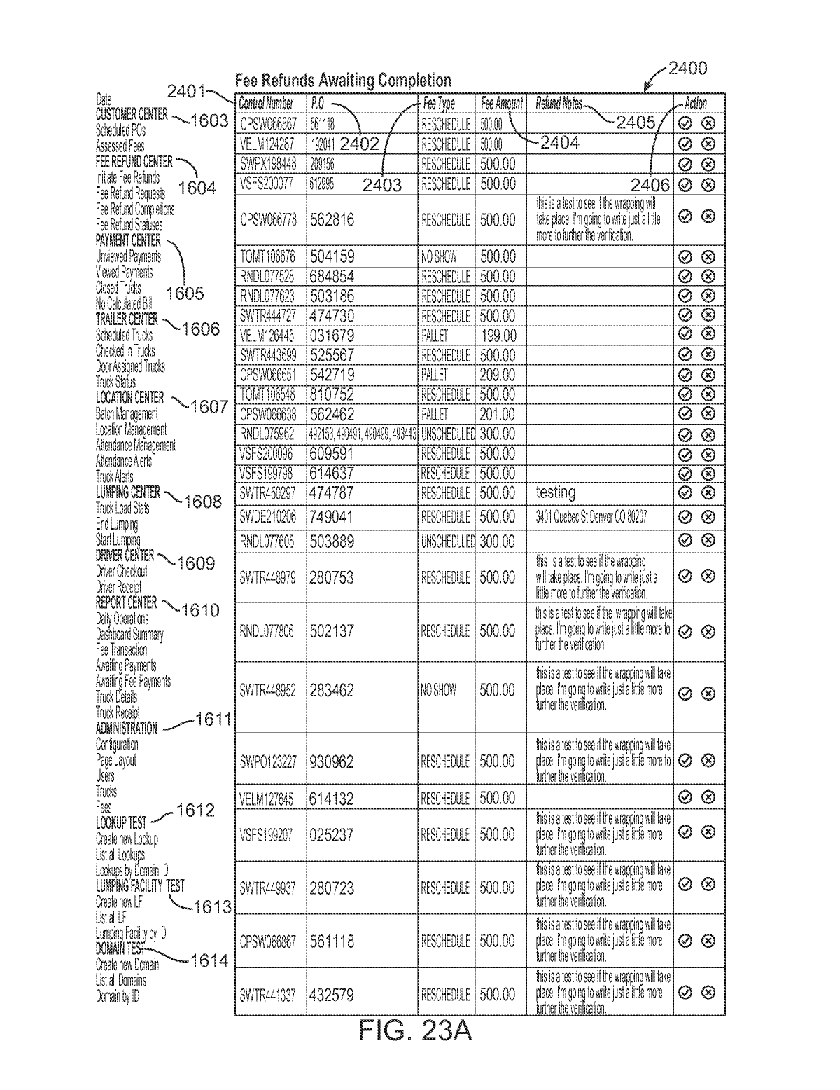

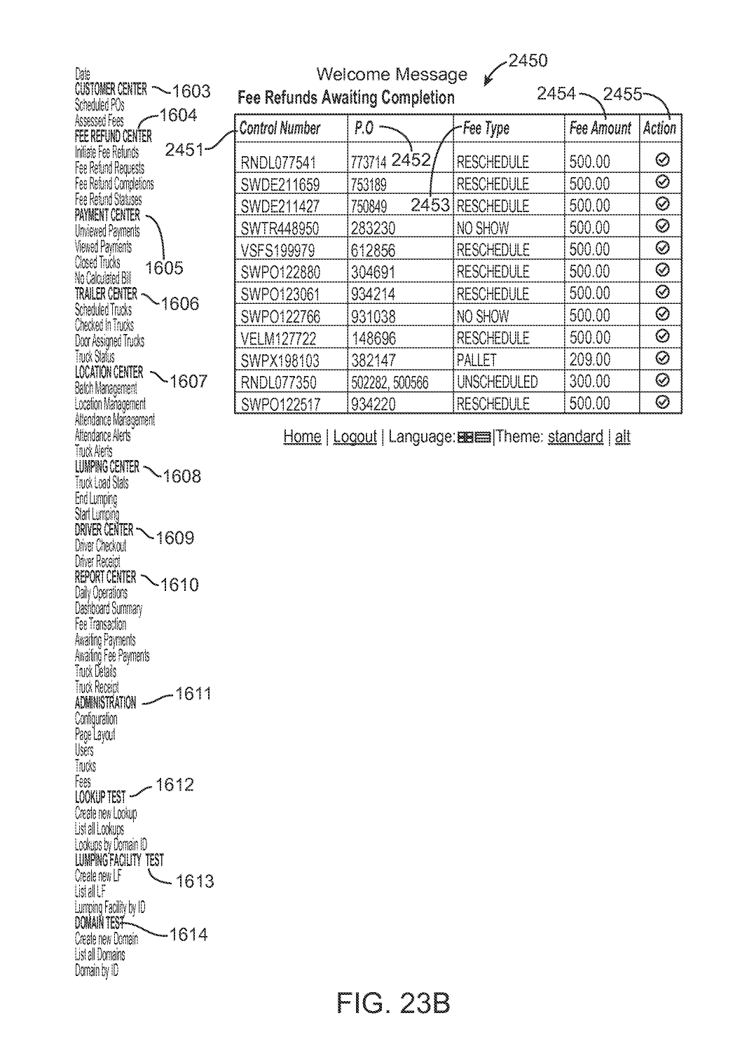

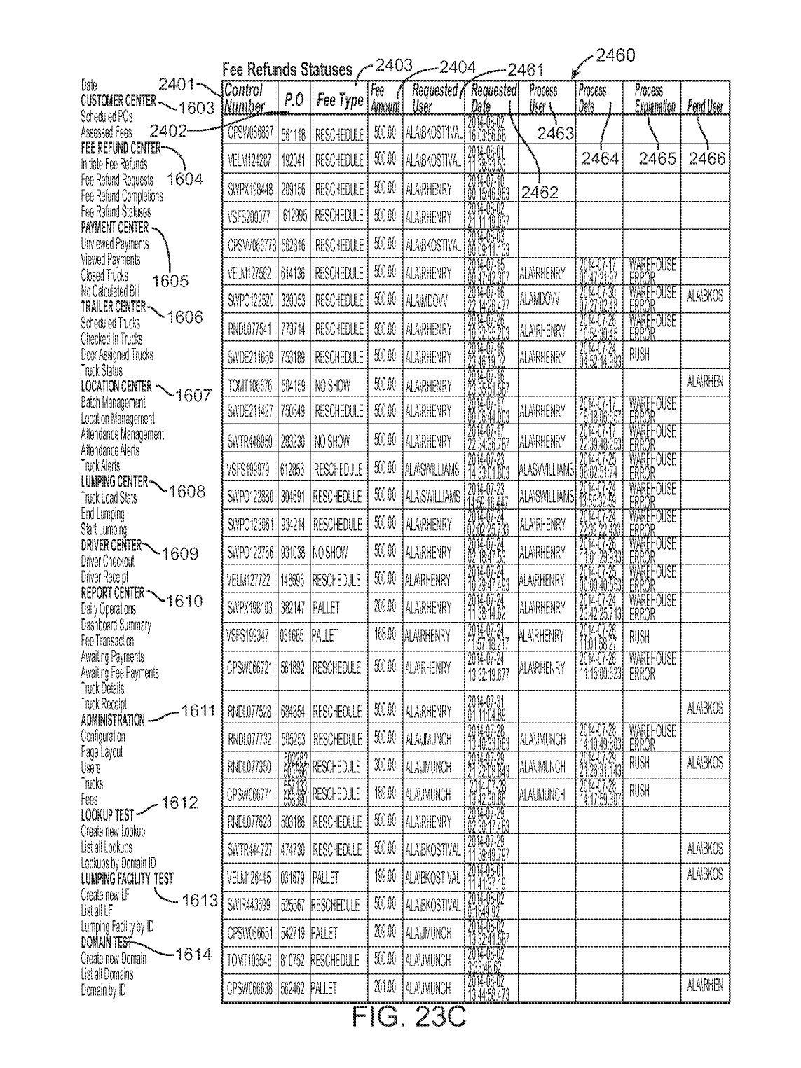

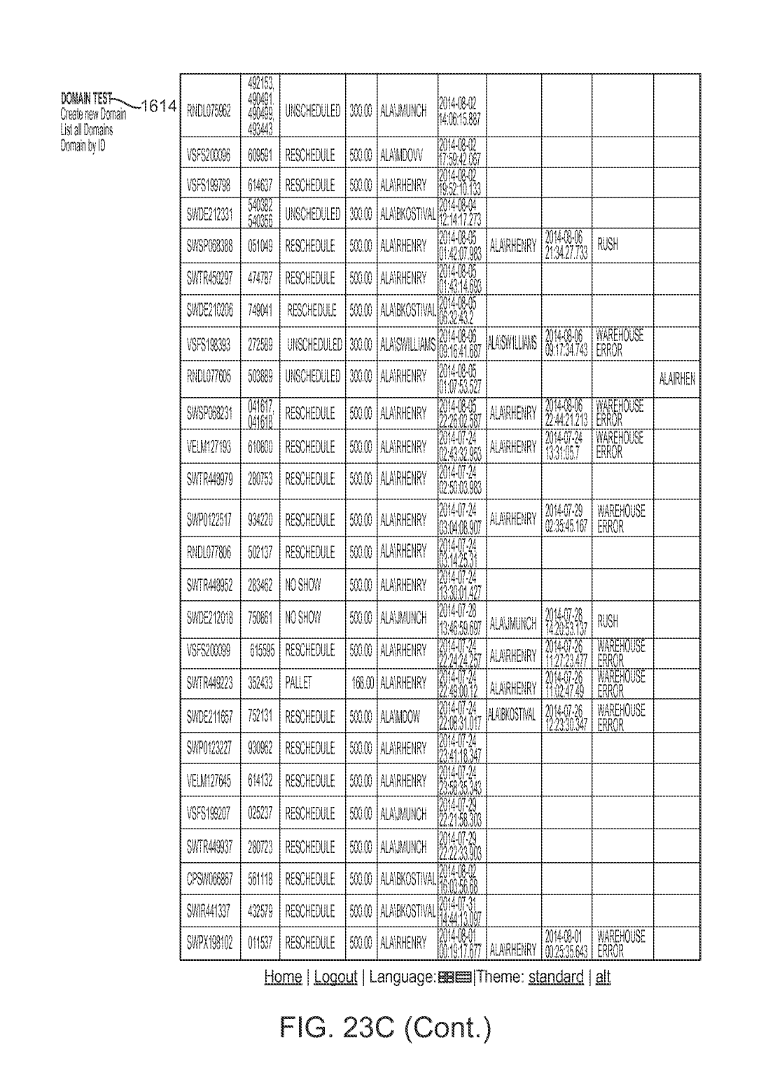

FIG. 23A shows an example view of fee refunds that are awaiting processing interface 2400, according to an embodiment of the invention. In one embodiment, the fee refunds that are awaiting processing interface 2400 includes various information that is displayed, such as control number 2401, PO 2402, fee type 2403, fee amount 2404, refund notes 2405, action 2406, etc. In one embodiment, after refund initiation, the authorized UL user may select to process the refund or pend the refund request for future processing. In one embodiment, the fee refunds that are awaiting processing interface 2400 shows the list of requested refunds with the Process (checkmark symbol under action 2406) or Pend (“x” symbol under action 2406). In one embodiment, once a refund is flagged for processing it no longer is displayed in the list but will be picked up in the completion list (FIG. 23B) after the refund invoice is generated. In one embodiment, if the UL user requests to pend the refund (e.g., delay), the refund will continue to appear in the list of the fee refunds that are awaiting processing interface 2400 for processing at a future date.

FIG. 23B shows an example view of fee refunds that are awaiting completion 2450, according to an embodiment of the invention. In one embodiment, the view for fee refunds that are awaiting completion 2450 includes various information, such as control number 2451, PO 2452, fee type 2453, fee amount 2454 and action 2455, etc. In one embodiment, at this refund step, the authorized UL user selects processed refunds for completion. The processed refund list view is displayed in the fee refunds that are awaiting completion 2450. In one embodiment, completion entails issuing a check and recording the check number associated with the refund. Once completed, the refund will be viewable in the refund status list for a particular duration, such as up to 90 days.

FIG. 23C shows an example view of fee refund status 2460, according to an embodiment of the invention. In one embodiment, the fee refund status 2460 includes various displayed information, such as control number 2401, PO 2402, fee type 2403, fee amount 2404, requested user 2461, requested date 2462, process user 2463, process date 2464, process explanation 2465, Pend user 2466, etc. In one embodiment, the fee refund status 2460 shows the list of initiated refunds and their individual status. A refund may be waiting for processing, pending and waiting for processing, in processing, waiting for completion or completed. In one embodiment, refund status information may be viewable in the form of an information bubble (or pop-up display) activated by hovering over an initiated refund or status symbol or icon (e.g., with a mouse curser, a finger, etc.).

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Though the present invention has been described with reference to certain versions thereof; however, other versions are possible. Therefore, the spirit and scope of the invention should not be limited to the description of the preferred versions contained herein.

What is claimed is:

1. A method for automated management of lumping services, comprising:
managing collection of on-site facility lumping services data;
managing payment collection for the lumping services;
providing customer integrated file uploads containing data elements for field operations related to the lumping services;
providing automated check-in and check-out of drivers at facilities for tracking lumping services;
scheduling purchase orders for the lumping services;
performing fee assessment for the purchase orders;
dynamically determining if a user initiated refund request should be granted for one or more of the purchase orders;
processing granted fee refund requests for the one or more purchase orders; and
providing one or more status displays for the lumping services.

2. The method of claim 1, further comprising:
providing vendor compliance information in real-time for display,
wherein scheduling purchase orders comprises scheduling purchase orders for one of a fee waiver and a fee prepayment.

3. The method of claim 2, wherein vendor compliance information is based on receiving schedules and determining vendor compliance categories and determining fees.

4. The method of claim 3, wherein the fees are determined at time of check-in and a driver is informed of the fees and a process for collecting the fees at time of payment.

5. The method of claim 4, further comprising:
dynamic identifying of timeliness of trucks per scheduled appointment time and identifying of unscheduled and rescheduled trucks.

6. The method of claim 5, wherein identifying timeliness comprises dynamically identifying rescheduled, unscheduled, and late trucks, wherein lumping services fees are assessed at check-in time at a distribution center.

7. The method of claim 1, wherein performing fee assessment comprises selecting a purchase order for fee waiver.

8. The method of claim 1, wherein refund requests are user initiated using a user interface, and a refund status viewing interface provides for selecting one of processing refunds and pending refunds;
wherein managing collection of lumping services data comprising use of hand-held mobile electronic devices for on-site management teams.

9. The method of claim 1, further comprising:
displaying truck list tabs in a user interface that represent flow and details in a lumping process at a particular location; and
displaying a lump current status based on time, assigned dock for trucks and assigned door number for the trucks.

10. The method of claim 9, further comprising:
dynamically displaying one of an active door time (ADT) view, a detention view, and a combined ADT and detention view for a dashboard summary for the lump current status.

11. The method of claim 10, wherein managing payment collection for the lumping services comprises:
collecting payment information; and
dynamically displaying the payment information and payment status information.

12. A non-transitory computer-readable medium having instructions which when executed on a computer performs a method comprising:
managing collection of on-site facility lumping services data using an automated lumping services management system;
managing payment collection for the lumping services;
providing customer integrated file uploads containing data elements for field operations related to the lumping services;
providing automated check-in and check-out of drivers at facilities for tracking lumping services;
scheduling purchase orders for one of a fee waiver and a fee prepayment;
performing fee assessment for the purchase orders;
determining if an initiated refund request should be granted for one or more of the purchase orders;
processing granted refund requests for the one or more purchase orders; and
providing one or more status displays for the lumping services.

13. The medium of claim 12, further comprising:
dynamically providing vendor compliance information in real-time for display, wherein vendor compliance information is based on receiving schedules and determining vendor compliance categories and determining fees.

14. The medium of claim 13, wherein the fees are determined at time of check-in and a driver is informed of the fees and a process for collecting the fees at time of payment.

15. The medium of claim 14, further comprising:
dynamic identifying of timeliness of trucks per scheduled appointment time and identifying of unscheduled and rescheduled trucks, wherein identifying timeliness comprises dynamically identifying rescheduled, unscheduled, and late trucks, wherein lumping services fees are assessed at check-in time at a distribution center.

16. The medium of claim 15, wherein performing fee assessment comprises selecting a purchase order for fee waiver, and
wherein managing collection of lumping services data comprising use of hand-held mobile electronic devices for on-site management teams.

17. The medium of claim 12, further comprising:
dynamically displaying one of an active door time (ADT) view, a detention view, and a combined ADT and detention view for a dashboard summary for the lump current status.

18. The medium of claim 17, wherein refund requests are user initiated using a user interface, and a refund status viewing interface provides for selecting one of processing refunds and pending refunds.

19. A system for automated management of lumping services, comprising:
a processor;
an operations and payment module that uses the processor for managing on-site facility lumping services, processes lumping services information using one or more databases, schedules purchase orders, performs fee assessment for the schedule purchase orders, manages payment collection and processing refunds for the lumping services;
a vendor compliance module that receives customer file uploads over a network from one or more vendor systems, wherein the customer file uploads comprise data elements for field operations related to the lumping services;
one or more user interfaces for providing automated check-in and check-out of drivers at facilities for tracking lumping services, and for providing one or more status displays for the lumping services.

20. The system of claim 19, further comprising:
dynamically providing vendor compliance information in real-time for display, wherein vendor compliance information is based on receiving schedules and determining vendor compliance categories and determining fees;
dynamically displaying one of an active door time (ADT) view, a detention view, and a combined ADT and detention view for a dashboard summary for lumping service current status.
